(19) United States
(12) Patent Application Publication
(10) Pub. No.: US 2026/0289472 A1
(43) Pub. Date: Sep. 24, 2026

(54) SYSTEM

(71) Applicant: SoftBank Group Corp., Tokyo (JP)

(72) Inventor: Amane ORITO, Tokyo (JP)

(73) Assignee: SoftBank Group Corp., Tokyo (JP)

(21) Appl. No.: 19/568,783

(22) Filed: Mar. 17, 2026

(30) Foreign Application Priority Data
Mar. 19, 2025 (JP) 2025-045089

(51) Int. Cl. G06Q 10/0639

(52) U.S. Cl. CPC G06Q 10/06393

(57) ABSTRACT

A system includes a processor that is configured to receive schedule and actual information of employees as input and evaluate an environmental burden to calculate a carbon-neutral score, recognize an emotional state of a user and provide a prompt to a generative AI model to instruct the generative AI model to adjust the carbon-neutral score based on the emotional state, provide a prompt to the generative AI model to instruct the generative AI model to recommend a schedule having a higher carbon-neutral score, and calculate a monthly performance using a statistical method.

### CROSS-REFERENCE TO RELATED APPLICATION

This application is based on and claims priority under 35 USC 119 from Japanese Patent Application No. 2025-045089 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional carbon management systems in workplaces mainly focus on collecting activity data and calculating environmental impact indicators such as CO2 emissions or similar carbon-related metrics. However, these systems generally lack mechanisms to adapt to the emotional state of users, to provide personalized guidance, or to sustain user engagement over time. As a result, employees often perceive carbon-neutral activities as a burden or as abstract numerical targets, leading to low motivation and limited behavioral change. Furthermore, conventional systems provide only simple reporting or dashboards without using advanced models such as generative AI models to generate context-aware prompts or recommendations. In addition, there is insufficient support for presenting individual and organizational scores in a way that effectively leverages competition and collaboration within organizations, and existing tools do not adequately employ gamification elements to continuously motivate users. Consequently, there is a need for a system that: (i) evaluates environmental burden and computes carbon-neutral scores based on employee schedule and actual information; (ii) recognizes the emotional state of the user and dynamically adjusts feedback or scoring; (iii) utilizes a generative AI model through prompts to recommend high-scoring schedules; (iv) performs statistical calculation of monthly performance; and (v) generates and notifies individual and organizational scores and integrates gamification elements to encourage sustainable behavioral change.

### SUMMARY

To solve the above-described problems, according to one aspect of the present invention, there is provided a system comprising a processor, wherein the processor is configured to receive schedule and actual information of employees as input and evaluate an environmental burden to calculate a carbon-neutral score. The processor is further configured to recognize an emotional state of a user and provide a prompt to a generative AI model to instruct the generative AI model to adjust the carbon-neutral score based on the emotional state. The processor is also configured to provide a prompt to the generative AI model to instruct the generative AI model to recommend a schedule having a higher carbon-neutral score, and to calculate a monthly performance using a statistical method. In some embodiments, the processor is configured to generate the carbon-neutral score for each individual and for each organization and to provide a prompt to instruct notification of the carbon-neutral score via an email system or a notification system, thereby enabling timely feedback and increasing awareness at both the individual and organizational levels. In further embodiments, the processor is configured to calculate scores of individuals and scores of departments and to provide a prompt to the generative AI model to instruct the generative AI model to provide a gamification element that motivates users to obtain a higher score by notifying the scores, for example through rankings, badges, challenges, or other game-like mechanisms. By integrating emotional-state-aware score adjustment, AI-driven recommendations, statistical monthly analysis, multi-level notifications, and gamification in a unified system, the invention enables continuous user engagement and effectively promotes environmentally friendly behaviors in an organizational context.

The term “processor” refers to one or more hardware processing units, such as a central processing unit (CPU), a graphics processing unit (GPU), a microcontroller, or any combination thereof, configured to execute instructions and perform the functions described in the claims.

The term “schedule and actual information of employees” refers to data representing planned activities and completed activities of employees, including at least information on dates, times, locations, transportation modes, energy consumption, and other parameters relevant to evaluating environmental burden.
The term “environmental burden” refers to a measure of negative impact on the environment associated with an activity, including, for example, greenhouse gas emissions, energy consumption, or resource usage, which can be quantified for use in calculating the carbon-neutral score.
The term “carbon-neutral score” refers to a numerical indicator computed based on the environmental burden of an employee's activities, where a higher score corresponds to lower environmental burden or closer alignment with carbon-neutral or environmentally friendly behavior.
The term “emotional state of a user” refers to a psychological or affective condition of a user, including, for example, happiness, stress, frustration, motivation, or similar sentiments, which can be inferred or recognized from input data such as user interactions, biometric data, or text or voice expressions.
The term “generative AI model” refers to a machine learning model configured to generate content, such as text, recommendations, or responses, in accordance with prompts, including, for example, large language models, generative adversarial networks, or other generative neural network architectures.
The term “prompt” refers to data, including a text string or structured parameter set, provided as input to a generative AI model to instruct or guide the generative AI model to perform a particular operation, such as adjusting a score, generating a recommendation, or creating gamification content.
The term “schedule having a higher carbon-neutral score” refers to a planned set of activities for an employee that, when evaluated by the system, yields a carbon-neutral score that is higher than a score of one or more alternative schedules.
The term “monthly performance” refers to a measure of an employee's or an organization's carbon-neutral behavior over a period of one month, derived by aggregating or statistically processing carbon-neutral scores for that period.
The term “statistical method” refers to a mathematical procedure used to analyze or aggregate data, including, for example, summation, averaging, variance calculation, normalization, ranking, or other statistical operations applied to carbon-neutral scores.
The term “individual” refers to a single employee or user of the system for whom a carbon-neutral score or performance is calculated and managed separately.
The term “organization” refers to a group entity, such as a company, a business unit, or a project team, that includes multiple individuals and for which carbon-neutral scores can be aggregated, analyzed, and reported.
The term “department” refers to a subdivision of an organization, such as a team, section, or functional group, comprising multiple individuals, for which a collective or average score can be calculated and used for comparison or gamification.
The term “email system” refers to any electronic mail infrastructure capable of sending, receiving, and managing email messages, including internal corporate email servers and external email services, used to notify users of carbon-neutral scores or related information.
The term “notification system” refers to a system or service configured to deliver electronic notifications, such as push notifications, in-application alerts, or system messages, to user devices regarding carbon-neutral scores, recommendations, or gamification elements.
The term “gamification element” refers to a feature that applies game design techniques, such as points, badges, levels, rankings, challenges, or rewards, to the carbon-neutral scoring context in order to motivate users to achieve higher scores and adopt environmentally friendly behaviors.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

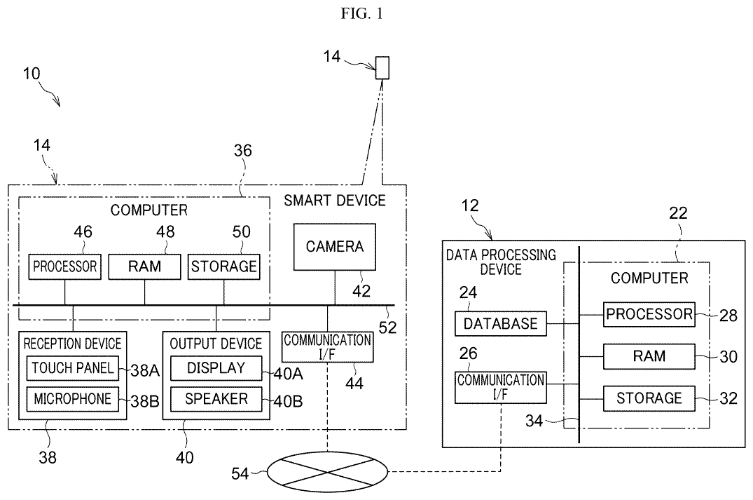

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

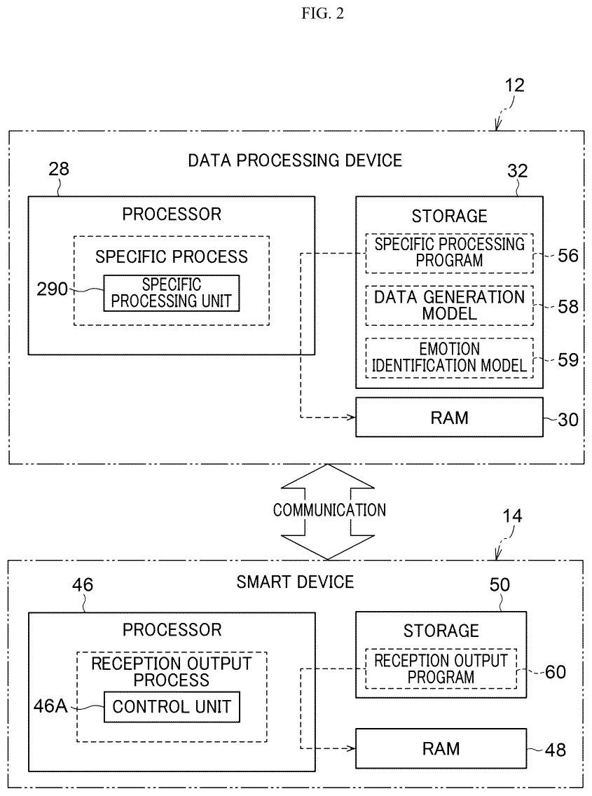

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented environmental assessment systems primarily perform simple aggregation of activity data, such as transport mode and energy consumption, and output static emission reports. Such systems suffer from several technical limitations. First, processing pipelines are typically decoupled: input acquisition, emission factor lookup, numerical calculation, scoring, and presentation are implemented as separate, loosely integrated modules, which leads to redundant data transformations, increased memory usage, and latency in producing usable feedback on resource-constrained terminal devices. Second, existing systems generally do not dynamically adapt their computation and output flows based on user state, such as an emotional state, and therefore fail to optimize the timing and format of computation results for user engagement, which in turn reduces the effectiveness of feedback-driven emission reduction. Third, communication between analytic components on the server side and external generative AI models is often ad hoc, with free-form text exchanges that are not grounded in structured numerical outputs, resulting in non-deterministic behavior, inconsistent recommendations, and difficulty in maintaining deterministic, reproducible system performance. Fourth, conventional systems typically lack an integrated mechanism to generate and manage time-series performance metrics, such as per-period and per-organization scores, and to convert these metrics into formally defined prompt sentences that drive automated configuration of notification flows and gamification elements via generative AI models. This makes it difficult to implement scalable, automated personalization of environmental scoring and recommendation logic without manual rule engineering.

Accordingly, there is a need for a computer-implemented technique that improves the way a processor acquires structured environmental activity data, performs emission factor-based calculations, generates normalized scores, and coordinates these numerical outputs with generative AI models through machine-generated prompt sentences. Such a technique should reduce redundant data handling, provide deterministic and efficiently computable score generation, and automatically construct structured prompts that allow external generative AI models to configure presentation, notification, and gamification logic in a controlled and system-optimized manner. Additionally, there is a need to improve server-side processing so that numerical time-series scoring and statistical aggregation can be tightly coupled with adaptive user-facing interfaces, while preserving a clear, machine-readable data flow between deterministic calculation modules and probabilistic AI-based content generation modules.

The specific processing by the specific processing unit 290 of the data processing device 12 in Example 1 is realized by the following means.

The present invention provides a server comprising a processor and a storage device, the processor being configured to receive, from a terminal device, structured activity information including schedule information and performance information for personnel, the activity information including transport mode information, travel distance information, and energy consumption information as input data; to acquire, from the storage device, greenhouse gas emission factor information corresponding to the transport mode information and electric power emission factor information; to calculate, using arithmetic processing on the server, an environmental load index by combining the travel distance information with the greenhouse gas emission factor information and the energy consumption information with the electric power emission factor information; to apply, to the environmental load index, predetermined scaling processing or normalization processing to calculate a carbon-neutral score; to aggregate the carbon-neutral score as time-series data to generate evaluation information for each predetermined aggregation period and for each individual unit and each organizational unit; to acquire a user emotional state and generate, in a structured and machine-generated manner, prompt sentences that include at least the carbon-neutral score, the evaluation information, and the user emotional state, the prompt sentences specifying at least one of a presentation method, an adjustment method, a notification content, a notification timing, and a gamification element related to the carbon-neutral score and the evaluation information; to provide the prompt sentences, as structured requests, to a generative AI model via an electronic communication interface; to receive, from the generative AI model, responses including recommended schedule patterns that reduce environmental load, notification configurations, and gamification configurations; and to generate and transmit, to the terminal device, output data including the carbon-neutral score, the evaluation information, and user interface control information reflecting the responses, such that the terminal device visually presents adaptive scores, recommendations, notifications, and gamification elements. This enables improvement of computer technology by integrating deterministic numerical processing and probabilistic content generation in a unified server-side pipeline, reducing redundant data transformations, enabling efficient and reproducible calculation and time-series aggregation of environmental load and carbon-neutral scores, and providing structured prompt-based control over generative AI models to automatically configure presentation, notification, and gamification logic while maintaining system-level determinism, scalability, and adaptability.

The term “activity information” refers to electronic data representing planned or actual actions of personnel, including at least schedule information and performance information such as transport mode, travel distance, and energy consumption.

The term “schedule information” refers to electronic data representing planned activities of personnel within a given time period, including at least planned transport modes, planned travel distances, and planned energy usage patterns.
The term “performance information” refers to electronic data representing actually executed activities of personnel within a given time period, including at least actual transport modes used, actual travel distances, and actual energy consumption.
The term “personnel” refers to individual users associated with an organization, such as employees or staff members, whose activity information is processed by the system.
The term “transport mode information” refers to data identifying a category of transportation used by personnel, such as public transportation, private vehicle, or non-motorized transportation, which is used to select corresponding emission factor information.
The term “travel distance information” refers to data indicating a distance traveled by personnel in association with an activity, expressed in a length unit such as kilometers or miles.
The term “energy consumption information” refers to data indicating an amount of energy used in association with an activity, expressed in an energy unit such as kilowatt-hours.
The term “storage device” refers to any non-transitory computer-readable medium capable of storing data and instructions, such as a magnetic storage device, an optical storage device, a semiconductor memory, or a combination thereof.
The term “greenhouse gas emission factor information” refers to data representing a coefficient that relates a unit of activity, such as distance traveled for a transport mode, to an amount of greenhouse gas emitted, typically expressed in mass per unit distance.
The term “electric power emission factor information” refers to data representing a coefficient that relates a unit of electric energy consumption to an amount of greenhouse gas emitted, typically expressed in mass per unit energy.
The term “environmental load index” refers to a numerical value or set of numerical values representing an environmental impact associated with activity information, derived at least from greenhouse gas emissions due to transportation and energy consumption.
The term “arithmetic processing” refers to execution of mathematical operations by a processor, including at least multiplication, addition, subtraction, division, aggregation, and scaling operations applied to numerical data.
The term “scaling processing” refers to a mathematical transformation that maps a numerical value from one range to another range according to a predetermined function, such as a linear scaling or a non-linear scaling.
The term “normalization processing” refers to a mathematical transformation that adjusts a numerical value relative to a reference distribution or range, such as dividing by a maximum value, applying z-score normalization, or applying min-max normalization.
The term “carbon-neutral score” refers to a normalized metric derived from the environmental load index that quantifies the environmental performance of activity information on a defined scale, where a higher score generally corresponds to a lower environmental load.
The term “evaluation information” refers to data that includes at least the carbon-neutral score and one or more derived metrics, such as aggregated scores over time or over groups, that are used to assess environmental performance.
The term “time-series data” refers to a sequence of data points, such as carbon-neutral scores or environmental load indices, that are indexed by time and represent changes or trends over successive time intervals.
The term “aggregation period” refers to a predefined time interval, such as a day, a week, or a month, over which environmental load indices or carbon-neutral scores are combined using a statistical method.
The term “individual unit” refers to a unit of aggregation corresponding to a single person, such as an individual employee, for whom environmental indices and scores are computed.
The term “organizational unit” refers to a unit of aggregation corresponding to a group within an organization, such as a department, team, or division, for which environmental indices and scores are computed.
The term “user emotional state” refers to data representing a psychological or affective condition of a user, such as stress level, motivation, or satisfaction, obtained through direct input, sensor data, or inference.
The term “prompt sentence” refers to a machine-generated natural-language or semi-structured text string that encodes a request, constraint, or description, which is provided as input to a generative AI model to obtain a corresponding output.
The term “generative AI model” refers to a machine learning model configured to generate content, such as text, based on input data including prompt sentences, using probabilistic or neural network-based techniques.
The term “schedule pattern” refers to a combination or sequence of planned activities, including at least transport mode choices and associated travel distances and energy usage, that can be evaluated for environmental load and scoring.
The term “high score schedule” refers to a schedule pattern that, when evaluated by the system, yields a carbon-neutral score that meets or exceeds a predetermined threshold or relative ranking.
The term “statistical method” refers to a computational technique for summarizing or analyzing data, including at least averaging, summing, counting, calculating variance or standard deviation, and computing distributions or percentiles.
The term “performance information for each individual unit and each organizational unit” refers to evaluation information that has been aggregated or computed separately for each person and for each group within an organization.
The term “display device” refers to any hardware component capable of visually presenting information to a user, such as a monitor, a smartphone display, a tablet display, or a wearable display.
The term “terminal device” refers to an end-user computing device, such as a smartphone, a tablet, a laptop computer, or a desktop computer, that communicates with the server and presents information to the user.
The term “information delivery device” refers to a computing system or service configured to send electronic messages, such as email messages, push notifications, or in-application alerts, to one or more terminal devices.
The term “electronic communication” refers to transmission of data between computing devices using a wired or wireless communication network, such as the Internet, a local area network, or a mobile communication network.
The term “notification content” refers to information included in a message sent to a user, such as current scores, performance summaries, recommendations, or reminders related to environmental performance.
The term “notification timing” refers to a time or schedule at which notification content is transmitted to a user, including periodic times, event-triggered times, or user-selected times.
The term “gamification elements” refers to features integrated into a user interface to encourage desired behavior by using game-like constructs, such as points, levels, badges, rankings, or rewards.
The term “comparison index” refers to a metric that allows comparison of environmental performance between different individual units or organizational units, such as relative scores or percentage differences.
The term “ranking index” refers to a metric that orders individual units or organizational units according to their environmental performance, such as a rank or position in a leaderboard.
The term “incentive index” refers to a metric used to determine or represent rewards, benefits, or recognition associated with environmental performance, which may be linked to points, badges, or other incentives.
The term “group unit” refers to a collection of multiple individual units that are treated as a single entity for purposes of aggregation, comparison, or gamification, and may correspond to an organizational unit or an arbitrary group.
The term “user interface control information” refers to data generated by the server that specifies how information, such as scores, recommendations, notifications, and gamification elements, should be arranged, formatted, or triggered for display on a terminal device.

In one embodiment, a server cooperates with a terminal and a user to implement the invention.

The server includes at least one processor, a main memory, a non-transitory storage device, and a network interface. The storage device stores program modules that, when executed by the processor, implement the environmental load calculation, carbon-neutral scoring, prompt sentence generation, generative AI model coordination, and user interface control. The server operates on a general-purpose computing platform such as a rack-mounted computer running a server operating system. The server uses an interpreter or runtime environment for a high-level language, such as a Python runtime, together with numerical and data-analysis libraries such as a table-processing library, a numerical computation library, and a statistics library. The server uses a database management system such as a relational database engine to persist activity information, emission factor information, scores, and configuration data.
The terminal includes at least one processor, a display device, an input device such as a touchscreen, and a wireless or wired communication interface. The terminal runs a browser or a native application framework that executes markup, stylesheet, and script resources. The terminal presents input forms and graphical representations of scores and recommendations. The user operates the terminal to provide activity information and to review calculated scores and generated recommendations.
The server stores activity information in structured data records. The server represents schedule information and performance information for personnel as records in database tables. The server defines, for example, an activity table including fields such as a personnel identifier, a date, a transport mode identifier, a travel distance value, a distance unit, an energy consumption value, and an energy unit. The server defines an emission factor table including fields such as a transport mode identifier and a greenhouse gas emission factor value expressed as mass per unit distance. The server defines an electric power factor table including fields such as a region identifier and an electric power emission factor value expressed as mass per unit energy.
The server receives structured activity information from the terminal over a network using a message format such as JavaScript Object Notation carried in secure HTTP requests. The terminal structures user-entered values into standardized fields, and the server parses the received payload into in-memory objects that map directly to database fields. The server validates that transport modes match entries in a master table, that distance values and energy values fall within allowed ranges, and that units are consistent. The server rejects or requests correction for invalid or inconsistent data. This strict validation and normalization process improves accuracy and reduces downstream error propagation compared to ad hoc or free-form data entry.
The server loads validated activity records and corresponding emission factor records into in-memory tabular data structures. The server uses a table-processing library to represent each table as a columnar data frame, which improves cache locality and allows vectorized arithmetic processing. The server performs a join operation between the activity data frame and the emission factor data frame on a key column corresponding to the transport mode identifier. The server then multiplies travel distance columns by corresponding emission factor columns using vectorized operations on arrays, rather than iterating record by record. The server similarly multiplies energy consumption columns by electric power emission factor columns. This design reduces the number of CPU instructions, minimizes cache misses, and increases throughput, thereby improving processing speed and energy efficiency compared to naive row-wise computation.
The server computes, for each record or for aggregated groups, an environmental load index as a sum of calculated emissions from transportation and energy consumption. The server stores the environmental load index in additional columns of the data frame and then persists aggregated results in dedicated tables for daily, weekly, or monthly summaries. The server applies scaling or normalization to convert the environmental load index into a carbon-neutral score. For example, the server uses a linear transformation that maps a reference range of emissions to a fixed score range, such as 0 to 100, or uses a statistical normalization technique that accounts for historical distributions for a population. The server applies these transformations using numerical libraries that operate over entire columns, thereby avoiding repeated function calls and conditional branching at record level.
The server aggregates carbon-neutral scores in time-series form. The server uses group-by and aggregation operations keyed by personnel identifier, organizational unit identifier, and aggregation period. The server stores resulting evaluation information, including per-period scores, moving averages, and statistical descriptors such as variance, in a time-series table. This data structure allows the server to retrieve trend information for efficient visualization and reduces the need to recompute historical statistics when new data arrives.
The terminal displays user interfaces constructed with script-based rendering and, optionally, charting libraries. The terminal receives from the server both raw numerical values and layout-related user interface control information that specifies which charts to render, which score thresholds to highlight, and which recommendations to show. By delegating layout decisions to the server in a structured manner, the system reduces redundant layout computations on the terminal and ensures consistent user experiences across devices.
The server acquires information about a user emotional state. The server may receive self-reported values through terminal input fields, or may receive processed affective signals from separate sensors or subsystems, such as wearables. The server stores emotional state information as numerical features, such as a stress score, an engagement score, or a fatigue score. The server uses these features as part of the input to prompt generation and to threshold logic that determines when to present certain recommendations or gamification elements. This integration of emotional features into the scoring and recommendation pipeline allows the server to adapt computational workflows and output formatting based on expected user receptiveness.
The server generates prompt sentences to interface with a generative AI model. The server constructs each prompt sentence using a template mechanism that combines deterministic numerical outputs and categorical descriptors with controlled natural-language patterns. The server avoids sending raw free-form text derived only from user input; instead, the server fills a structured template with values such as the latest carbon-neutral score, historical average scores, variance, organizational benchmarks, and emotional state indicators. The server, for example, generates prompt sentences such as:
“Employee A commutes by train with a daily round-trip distance of 40 km and consumes 50 kWh of office energy per day. The resulting CO₂ emissions are 22 kg per day and the carbon-neutral score is 89 on a 0-100 scale. Propose three concrete actions to further reduce emissions without significantly increasing commute time.”
“Using an emission factor of 0.05 kg CO₂ per km for train and 0.4 kg CO₂ per kWh for electricity, calculate the daily CO₂ emissions and estimate a carbon-neutral score on a 0-100 scale for an employee who travels 20 km one way by train and uses 50 kWh in the office. Then, explain how the employee can improve the score by changing transport or reducing energy use.”
“Compare the environmental impact of two employees: Employee A commutes by car 10 km one way and uses 20 kWh per day, and Employee B commutes by train 20 km one way and uses 50 kWh per day. Assume emission factors of 0.2 kg CO₂/km for car, 0.05 kg CO₂/km for train, and 0.4 kg CO₂/kWh for electricity. Explain which employee has a better carbon-neutral score and why, and propose actions for each to improve.”
The server uses such prompt sentences to convey precisely structured context to the generative AI model, including explicit emission factors, numerical results, and performance thresholds. This reduces ambiguity and improves reproducibility of AI outputs.
The server interacts with a generative AI model hosted locally or remotely. In one embodiment, the server executes a neural network model that implements a sequence-to-sequence architecture with an encoder-decoder structure and attention mechanisms. The server uses a model with multiple transformer layers, each including multi-head self-attention sub-layers and feedforward sub-layers. The server stores model parameters, such as weight matrices and bias vectors, in a model storage region and loads them into memory for inference. The server represents textual tokens using embeddings in a fixed-dimensional vector space. The server encodes input tokens from the prompt sentence, processes them through stacked transformer layers, and decodes a sequence of output tokens representing a generated recommendation or explanation.
The server pre-trains or fine-tunes the generative AI model using supervised learning on a corpus that includes domain-specific environmental scenarios and user feedback patterns. The server uses a loss function such as cross-entropy loss to measure the difference between model outputs and target sequences. The server performs gradient-based optimization using algorithms such as stochastic gradient descent or adaptive moment estimation. The server updates model weights by computing gradients via backpropagation through the neural network. The server may perform data augmentation by paraphrasing training sentences or varying numerical values within realistic ranges to improve generalization. These training operations produce a model that can generate coherent, domain-consistent textual content in response to structured prompt sentences.
The server does not delegate numerical calculation of emissions or scores to the generative AI model. Instead, the server constrains the model to operate primarily in an explanatory and configuration-generating role. The server uses the generative AI model to generate recommendation content, notification phrasing, and gamification descriptions based on deterministic computational results and user context. This separation of concerns allows the server to maintain deterministic numerical accuracy while leveraging the model for user-facing text and for generating high-level configuration instructions for interface behavior. The server interprets certain outputs from the generative AI model as control hints rather than as direct executable logic. For example, the server may parse tags, keywords, or structured phrases embedded in the generated text to identify which types of visualizations to emphasize, which thresholds to color-code, or which reward levels to activate. The server defines a mapping from such tags to concrete user interface control parameters. By constraining the interpretation of AI outputs to a structured set of control instructions, the server reduces risk of unintended behavior and maintains system-level control.
The server uses this architecture to improve computer technology in several ways. The server reduces redundant parsing and transformation operations by using consistent data structures from initial ingestion through aggregation and presentation configuration. The server improves calculation efficiency by using vectorized operations and columnar in-memory representations. The server reduces communication load by transmitting compact numerical summaries and concise prompt sentences, rather than bulky raw logs, to the generative AI model. The server improves data management by storing normalized activity records and emission factors in indexed relational tables, reducing query time and enabling efficient time-series operations. The server improves precision by separating deterministic numerical modules from probabilistic text-generation modules, thereby avoiding rounding errors or miscalculations that could occur if a language model attempted to emulate numeric computation.
The terminal presents gamification elements and notifications based on both deterministic scores and AI-generated configuration. The terminal renders leaderboards, progress bars, and badges according to control instructions received from the server. The server calculates ranking indices and incentive indices using well-defined statistical methods and passes these as numerical values, while the generative AI model provides narrative descriptions or motivational phrasing. This separation allows the system to maintain precise numerical logic while offering flexible user engagement strategies.
The user benefits from more timely and context-sensitive feedback because the server integrates emotional state features and historical score patterns when deciding when and how to request AI-generated recommendations. For example, when a user consistently shows high stress and declining scores, the server modifies the prompt sentence to explicitly request supportive and incremental suggestions rather than aggressive targets. This adaptive mechanism leverages machine-generated templates and structured features to tailor interactions, without requiring manually coded rule sets for every scenario.
The server can implement alternative embodiments. In one variation, the server hosts the generative AI model locally and performs inference entirely within the same hardware, thus avoiding network latency and improving privacy. In another variation, the server uses a smaller on-device model for preliminary classification, such as determining whether to request detailed recommendations, and only calls a larger external model for complex cases. In another variation, the server modifies the scoring function to use non-linear mappings or piecewise-defined functions, and updates scaling parameters based on organization-wide calibration. In yet another variation, the server employs different neural architectures, such as recurrent neural networks or hybrid transformer-convolutional structures, with different layer depths, attention head counts, and embedding dimensions.
The server may also integrate additional technical optimizations, such as caching emission factor lookups, precomputing baseline scores for standard commute patterns, and compressing historical time-series via downsampling or dimensionality-reduction techniques. These measures further decrease computation time and storage requirements, and reduce network bandwidth consumption when transmitting summaries to terminals.
Through these configurations, the server, the terminal, and the user cooperate in a system that is not limited to abstract calculations. The system implements specific data structures, algorithms, and model architectures that improve calculation speed, accuracy, data management, and adaptive presentation, thereby constituting a concrete improvement in computer technology rather than a mere automation of human mental processes.

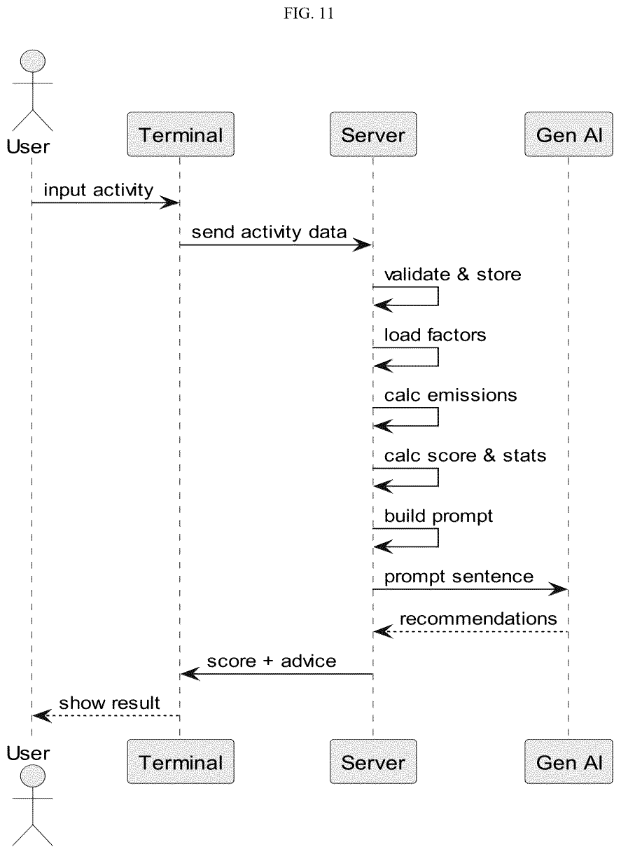

The following describes the processing flow using FIG. 11.

### Step 1:

The terminal displays an activity input screen for the user.
The terminal presents form fields for transport mode, travel distance, distance unit, energy consumption, energy unit, date, and personnel identifier.
The user inputs values such as “train,” “20,” “km,” “50,” “kWh,” and a specific date, and selects or confirms their own identifier.
The terminal validates the input locally, for example checking that distance and energy values are numeric and greater than or equal to zero.
Input: no prior system data; the user's raw keystrokes and selections.
Output: a structured set of activity values in memory on the terminal (e.g., transport mode, distance, energy, date, personnel ID) ready for transmission.

### Step 2:

The terminal converts the structured activity values into a standardized message.
The terminal maps each screen field to a key in a logical structure, such as “transport_mode,” “distance_value,” “distance_unit,” “energy_value,” “energy_unit,” “activity_date,” and “personnel_id.”
The terminal packages these key-value pairs into a serialized payload and attaches metadata such as a timestamp and device identifier.
The terminal sends the payload to the server using an HTTPS request to a predefined endpoint.
Input: the structured activity values stored in the terminal's memory.
Output: a network message containing normalized activity information transmitted to the server.

### Step 3:

The server receives the network message containing the activity information.
The server parses the received payload and converts it into in-memory objects, such as records or dictionaries, that correspond to database fields.
The server performs backend validation, confirming that the transport mode exists in a master transport table, that distance and energy values fall within allowed ranges, and that units are recognized.
The server rejects invalid entries or flags them for correction and logs validation errors if necessary.
Input: the serialized payload from the terminal containing user-entered activity information.
Output: a validated, normalized activity record in the server's memory, or an error response if validation fails.

### Step 4:

The server writes the validated activity record into a persistent activity table in a relational database.
The server opens a database transaction, inserts a new record with fields such as personnel ID, activity date, transport mode ID, distance, distance unit, energy, and energy unit, and then commits the transaction.
The server assigns a unique activity identifier to the record, which can be used later for retrieval and aggregation.
Input: the validated activity record in memory.
Output: a stored activity record in the database with a unique identifier and a confirmation status to the server logic.

### Step 5:

The server retrieves relevant emission factor records needed to compute environmental load.
The server queries an emission factor table to obtain the greenhouse gas emission factor corresponding to the specified transport mode and the electric power emission factor corresponding to the applicable region or category.
The server loads these emission factors into variables or tabular structures in memory.
Input: the normalized activity record (including transport mode, distance, energy) and access to emission factor tables.
Output: emission factor values (transport-mode emission factor and electric power emission factor) associated with the activity.

### Step 6:

The server computes the environmental load index for the activity using vectorized or batched arithmetic operations.
The server multiplies the travel distance by the transport-mode emission factor to obtain transport-related emissions.
The server multiplies the energy consumption by the electric power emission factor to obtain energy-related emissions.
The server sums these emission components to derive the total environmental load index for the activity, expressed, for example, in kilograms of equivalent greenhouse gas.
Input: travel distance value, energy consumption value, transport-mode emission factor, and electric power emission factor.
Output: a numerical environmental load index for the activity, along with separate transport and energy emission values.

### Step 7:

The server aggregates environmental load indices and activity records over a time period for each personnel or organizational unit.
The server groups records by personnel ID and by aggregation period, such as day, week, or month, and computes sums or averages of environmental load indices for each group.
The server stores the aggregated results in a time-series table with fields such as personnel ID, period start, period end, total emissions, and number of activities.
Input: individual environmental load indices and associated identifiers (personnel, date, organization).
Output: aggregated environmental load indices per aggregation period and per unit (individual and organizational) stored in the server's database.

### Step 8:

The server converts the environmental load indices into carbon-neutral scores.
The server applies a predetermined scaling or normalization function, for example mapping a range of emission values to a 0-100 score scale.
The server executes arithmetic operations such as multiplication, division, and shifting to transform each aggregated environmental load index into a score value.
The server clips the resulting scores to a defined range and stores them in a scores table associated with personnel IDs and aggregation periods.
Input: aggregated environmental load indices and scaling/normalization parameters.
Output: carbon-neutral scores for each personnel and period, stored together with the underlying indices.

### Step 9:

The server generates evaluation information combining time-series carbon-neutral scores and related statistics.
The server calculates additional metrics such as moving averages, variance, and ranking positions within an organizational unit using statistical functions over the stored scores.
The server creates structured evaluation records that include current period score, historical trend indicators, and comparison values against organizational benchmarks.
Input: per-period carbon-neutral scores and related historical data.
Output: evaluation information records summarizing environmental performance for each individual and each organization.

### Step 10:

The server acquires or updates user emotional state information.
The server receives emotional indicators from the terminal, such as a self-reported stress level, or obtains such indicators from connected sensors or subsystems.
The server stores the emotional state as numerical features (for example, a scale value) linked to a personnel ID and a timestamp.
The server selects or updates the emotional state features to be used in subsequent prompt sentence generation.
Input: emotional state data from the terminal or external sources.
Output: numerical emotional state features associated with the user, stored and available in memory for prompt generation.

### Step 11:

The server prepares a prompt sentence to be used as input to a generative AI model.
The server selects relevant numerical and categorical information, such as the latest carbon-neutral score, recent trend, environmental load breakdown, organizational benchmarks, and emotional state features.
The server fills a template with these values to construct a natural-language prompt sentence that encodes specific instructions, constraints, and goals.
The server, for example, generates prompt sentences such as:
“Employee A commutes by train with a daily round-trip distance of 40 km and consumes 50 kWh of office energy per day. The resulting CO₂ emissions are 22 kg per day and the carbon-neutral score is 89 on a 0-100 scale. Propose three concrete actions to further reduce emissions without significantly increasing commute time.” “Using an emission factor of 0.05 kg CO₂ per km for train and 0.4 kg CO₂ per kWh for electricity, calculate the daily CO₂ emissions and estimate a carbon-neutral score on a 0-100 scale for an employee who travels 20 km one way by train and uses 50 kWh in the office. Then, explain how the employee can improve the score by changing transport or reducing energy use.”
“Compare the environmental impact of two employees: Employee A commutes by car 10 km one way and uses 20 kWh per day, and Employee B commutes by train 20 km one way and uses 50 kWh per day. Assume emission factors of 0.2 kg CO₂/km for car, 0.05 kg CO₂/km for train, and 0.4 kg CO₂/kWh for electricity. Explain which employee has a better carbon-neutral score and why, and propose actions for each to improve.”
Input: numerical scores, environmental load components, historical statistics, and emotional state features.
Output: one or more structured prompt sentences in natural language ready to be sent to a generative AI model.

### Step 12:

The server sends the prompt sentence to a generative AI model and receives a response.
The server transmits the prompt sentence over a communication interface to a model execution environment, which may be local or remote.
The server receives text output from the generative AI model, such as recommended actions, explanatory text, or suggested gamification configurations.
The server may parse the output to detect structured cues, such as keywords or tags that indicate priority levels, recommended visualization types, or reward tiers.
Input: prompt sentences generated based on computed scores and context.
Output: model-generated text content and control hints representing recommendations, explanations, or configuration suggestions.

### Step 13:

The server integrates the generative AI model output with deterministic evaluation information.
The server combines the model-generated recommendations and control hints with the computed carbon-neutral scores, environmental load breakdowns, and ranking indices.
The server constructs a response package that includes numerical data, textual recommendations, notification content, and gamification parameters (such as points or rank changes).
The server formats this package as structured output for use by the terminal's user interface logic.
Input: evaluation information and generative AI model output.
Output: a unified response including scores, environmental metrics, recommendations, and interface control parameters.

### Step 14:

The server transmits the unified response to the terminal.

The server sends the structured response through an HTTPS response message to the originating terminal or to one or more subscribed terminals.

The server may also send separate notification messages to an information delivery device if configured to do so.
The server thereby provides all necessary data for visualization, notifications, and gamification display.
Input: the unified response object in server memory.
Output: a network message containing numerical values, textual content, and user interface control information delivered to the terminal.

### Step 15:

The terminal receives the unified response from the server and updates the user interface.

The terminal parses the structured response and extracts components such as the carbon-neutral score, environmental load breakdown, ranking position, recommended actions, and any gamification elements. The terminal renders visual components such as gauges, charts, leaderboards, and badges on the display, and shows the textual recommendations generated by the generative AI model. The terminal may trigger notifications or highlight certain UI elements based on the control parameters included in the response.

Input: the unified response from the server containing scores, metrics, and recommendations.
Output: an updated visual display and, optionally, local notifications visible to the user.

### Step 16:

The user reviews the displayed scores, explanations, and recommendations on the terminal.
The user interprets the carbon-neutral score, inspects the breakdown of emissions, and reads the proposed actions or guidance.
The user may change future behavior, such as selecting different transport modes or reducing energy consumption, and may input new planned activities into the terminal.
The user's new inputs become new activity information that will be processed in subsequent iterations of the above steps.
Input: the visual and textual output presented on the terminal's display.
Output: user decisions and new activity inputs that feed back into the system for future processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional environmental performance management systems typically rely on batch processing of coarse-grained data and static rule sets. Such systems suffer from several technical limitations. First, conventional systems often maintain heterogeneous data flows for human-related activity information and equipment-related sensor information, which leads to fragmented data processing pipelines, redundant computations, and increased latency in deriving combined environmental indicators. Second, traditional architectures usually compute fixed environmental scores using pre-defined formulas, without dynamically adapting scoring logic or optimization proposals in response to changing data patterns, system constraints, or user behavior. Third, most existing systems lack an integrated mechanism to automatically transform large volumes of time-series sensor data and user activity logs into actionable optimization patterns in real time, resulting in inefficient use of processing resources and delayed feedback to users. Fourth, conventional systems do not effectively exploit generative models in a structured manner; prompts are often ad hoc, and there is no coordinated framework to generate, verify, and filter proposals from a generative model based on machine constraints and environmental indices. This can lead to non-executable recommendations, unnecessary network traffic, and increased computational overhead.

Furthermore, in many deployments, the server-side processing for environmental scoring and recommendation generation is not tightly integrated with user interaction flows. Score computations, proposal generation, and user selections are frequently handled in separate subsystems, which forces repeated data transformation and cross-system synchronization. This fragmented architecture degrades throughput, increases memory usage, and complicates maintenance of consistency between stored plan information, live sensor streams, and applied optimization patterns. As a result, the overall computing system cannot efficiently close the loop from data acquisition, to scoring, to validated generative suggestions, to user-confirmed configuration changes, and back to recalculated environmental indices.
Accordingly, there is a need for an improved computer-implemented technique and system architecture that: (i) unifies acquisition and processing of personnel behavior plan information and equipment sensor information; (ii) computes environmental load indices and performance values in an integrated pipeline; (iii) programmatically constructs prompt sentences for a generative model in a structured and data-aware manner; (iv) algorithmically verifies and filters the generative model's natural-language proposals against environmental indices and equipment constraints; and (v) updates behavior plan information and equipment operation conditions in a way that supports efficient recomputation of environmental load indices. Such an architecture should improve processing efficiency, reduce redundant computation, and enhance the technical performance of the server in generating and applying optimized behavior and operation patterns in near real time.

The specific processing by the specific processing unit 290 of the data processing device 12 in Application Example 1 is realized by the following means.

The present invention provides a server comprising a processor configured to acquire, via one or more communication interfaces, behavior plan information and behavior result information related to personnel, and acquire, via at least one sensor interface, time-series operation state information and energy consumption information related to equipment, the processor further configured to normalize and integrate the behavior information and the equipment information in a unified data structure, calculate an environmental load index for the personnel and for the equipment based on the unified data structure, and aggregate the environmental load index over predetermined time units to generate performance values; the processor further configured to automatically construct a structured prompt sentence including numerical representations of the environmental load index, the performance values, and operation constraint information, provide the prompt sentence to a generative information processing model, receive natural-language proposal content from the generative information processing model, and convert the natural-language proposal content into structured behavior plan candidates and equipment operation pattern candidates; the processor further configured to algorithmically verify the structured candidates against stored constraint information for the equipment and the personnel, filter out non-executable candidates, and generate a reduced set of executable behavior plan candidates and executable equipment operation pattern candidates; and the processor further configured to provide the executable candidates to a user terminal for selection, receive selection operations from the user terminal, update the stored behavior plan information and equipment operation conditions based on the selection operations, and trigger incremental recalculation of the environmental load index and the performance values using the updated information. This enables an integrated and technically improved server-side processing pipeline that unifies multi-source data acquisition, environmental index computation, generative model interaction through structured prompt sentences, automatic verification and filtering of generative proposals, and incremental re-computation after user-approved changes, thereby reducing redundant computation, lowering response latency, and enhancing the efficiency and reliability of computer-based environmental optimization.

The term “personnel” refers to human actors whose behavior plans and behavior results are managed and evaluated by the system.

The term “behavior plan information” refers to data describing scheduled or intended activities of personnel, including but not limited to planned tasks, planned travel routes, planned movement methods, and planned usage of resources within a specified time period.
The term “behavior result information” refers to data describing actual activities performed by personnel, including but not limited to realized tasks, actual travel routes, actual movement methods, and actual energy consumption associated with those activities.
The term “movement method information” refers to data indicating a mode or pattern of movement used by personnel, including but not limited to transportation modes, movement distances, and movement durations.
The term “energy consumption information” refers to data representing the amount of energy used by personnel or equipment over a given time period, including but not limited to electrical energy, fuel consumption, and other measurable energy resources.
The term “equipment” refers to physical devices or machinery whose operation state and energy consumption are monitored and controlled by the system.
The term “operation state information” refers to data indicating the operational status of equipment, including but not limited to active or idle states, runtime durations, operation modes, and motion states.
The term “detection device” refers to a sensing component or sensor system configured to measure physical quantities related to the equipment, including but not limited to power, current, voltage, position, speed, and temperature.
The term “time-series” refers to a sequence of data points indexed or ordered by time, in which each data point corresponds to a measurement or event occurring at a specific time.
The term “environmental load index” refers to a numerical indicator calculated from behavior plan information, behavior result information, operation state information, and energy consumption information, and representing an environmental impact level such as greenhouse gas emissions, resource consumption, or energy efficiency.
The term “performance values” refers to aggregated metrics computed over predetermined time units, based on one or more environmental load indices, and representing summarized environmental performance for personnel or equipment.
The term “predetermined time units” refers to defined time intervals used for aggregation and evaluation, including but not limited to hours, days, weeks, and months.
The term “generative information processing model” refers to a model implemented by a computing system that generates output data, including natural-language text, in response to input data, and that is capable of processing prompt sentences to produce proposed plans or patterns.
The term “prompt sentence” refers to a structured textual input provided to a generative information processing model, the input including numerical and descriptive information derived from the environmental load index, performance values, and constraint information, and instructing the model to generate proposals or explanations.
The term “proposal content” refers to natural-language output produced by a generative information processing model in response to a prompt sentence, the output including recommended behavior plans, equipment operation patterns, or explanatory descriptions.
The term “behavior plan candidates” refers to proposed alternative or modified behavior plans for personnel, derived from the proposal content of the generative information processing model and represented in a structured format suitable for validation and execution.
The term “equipment operation pattern candidates” refers to proposed alternative or modified operation patterns for equipment, derived from the proposal content of the generative information processing model and represented in a structured format suitable for validation and execution.
The term “operation constraint information” refers to data defining limitations or rules applicable to the operation of equipment or the activities of personnel, including but not limited to capacity limits, safety rules, scheduling constraints, and regulatory requirements.
The term “executable behavior plan candidates” refers to behavior plan candidates that have been verified against operation constraint information and determined to be feasible for implementation.
The term “executable equipment operation pattern candidates” refers to equipment operation pattern candidates that have been verified against operation constraint information and determined to be feasible for implementation.
The term “display device” refers to an output apparatus or user interface component configured to visually present information to a user, including but not limited to a monitor, a touch screen, or a mobile device display.
The term “user” refers to a human operator who views the presented information on the display device, performs selection operations on proposed candidates, and interacts with the system to adjust behavior plans or equipment operation conditions.
The term “selection operation” refers to an input action performed by a user, via a user interface, to approve, modify, or reject one or more of the presented behavior plan candidates or equipment operation pattern candidates.
The term “user terminal” refers to a computing apparatus operated by a user, configured to communicate with the server, present information through a display device, and accept selection operations and other input from the user.
The term “external communication means” refers to a communication mechanism or infrastructure used to transmit information between the server and external devices, including but not limited to wired or wireless networks, messaging systems, and notification services.
The term “ranking information” refers to data indicating a relative order among personnel units or organizational units based on environmental load indices or performance values.
The term “achievement information” refers to data representing a degree of progress toward environmental performance goals or thresholds for personnel units or organizational units.
The term “reward information” refers to data defining incentives associated with environmental performance, including but not limited to points, badges, levels, and other gamified rewards.
The term “gamified elements” refers to presentation components that apply game design principles, including ranking information, achievement information, and reward information, to encourage users to improve environmental performance.
The term “incremental recalculation” refers to a computation process in which updated environmental load indices or performance values are calculated using changed portions of stored information, without recomputing all values from scratch.

In one or more embodiments, a server, a terminal, and a user cooperate to implement the claimed system. The server executes an environmental optimization program on computing hardware, the terminal provides an interactive user interface, and the user supervises and confirms behavior plan changes and equipment operation pattern changes. The server executes a program on general-purpose computing hardware, for example, a multi-core processor, a volatile memory, a non-volatile storage device, and network interfaces running on an operating system such as a server-class operating system. The server stores behavior plan information, behavior result information, operation state information, and energy consumption information in one or more data stores, such as a relational database system and, in some embodiments, a time-series database system. The server executes software components including a data ingestion module, a feature extraction module, an environmental index computation module, a generative AI interface module, a candidate verification module, and an incremental recomputation module.

The server uses a data ingestion module to receive behavior plan information and behavior result information from the terminal over a packet-switched network. The server stores these data in tables such as a “behavior_plans” table and a “behavior_results” table. Each record includes fields generalized as identifiers for personnel, timestamps, activity types, movement method categories, distances, and estimated or measured energy consumption values. The server also uses the data ingestion module to receive operation state information and energy consumption information from sensors or programmable control devices attached to equipment. In one embodiment, the server receives sensor signals via an industrial communication protocol and maps the signals into records in “equipment_states” and “equipment_energy” tables. Each record includes a time index, an equipment identifier, an operation state flag, a measured energy value, and optionally a motion-related feature such as travel distance or axis displacement.
The server uses a feature extraction module to normalize and integrate heterogeneous data into a unified data structure. The server converts behavior plan and result data and equipment sensor data into vector representations. For example, the server encodes movement methods as categorical indices, converts distances to a common unit, and maps energy readings into a unified numeric scale. The server loads data from storage into in-memory data frames using a data analysis library, applies unit normalization, missing-value imputation, and outlier removal, and generates derived features such as “energy per unit distance” or “idle energy consumption rate.” The server stores the resulting feature vectors in a “feature_cache” structure to enable efficient reuse and incremental updates.
The server uses an environmental index computation module to calculate an environmental load index for each personnel unit and each equipment unit. In one embodiment, the server applies a weighted linear combination of features, where the server multiplies each feature (for example, total energy, travel distance, idle ratio) by a predefined coefficient and sums the results. In an alternative embodiment, the server applies a non-linear scoring function, such as a piecewise linear function or a logistic function, to penalize disproportionate energy spikes or excessive idle consumption. The server stores the calculated environmental load index in “personnel_env_index” and “equipment_env_index” tables. The server then aggregates these indices over predetermined time units, such as days or months, by grouping data records by time interval and computing summary statistics, including sums, averages, and variability. The server stores these aggregated values as performance values in a “performance_summary” table.
The server uses a generative AI interface module to interact with a generative AI model. In one embodiment, the generative AI model is a transformer-based neural network model hosted on a remote inference service. The server prepares a prompt sentence that encapsulates numerical values of the environmental load index, performance values, and operation constraint information. The server constructs the prompt sentence according to a defined template, in which the server embeds feature values and context information. For example, the server generates a prompt sentence such as:
“The server has collected the following data for a robot: daily energy consumption: 50 kWh, movement distance: 2 km, operation time: 10 hours. Based on this data, calculate an environmental load score on a scale from 0 to 100, briefly explain the calculation logic, and propose at least three more energy-efficient operation patterns that keep the same production output.”
In another example, the server generates a prompt sentence such as:
“Using the daily energy consumption and movement distance of an industrial robot, generate a human-readable explanation of its environmental load score and suggest concrete changes to its motion trajectory and scheduling to improve energy efficiency by at least 20% without reducing throughput.”
In a further example related to personnel, the server generates a prompt sentence such as:
“Given that an employee commutes 20 km by car five days a week and uses high-energy equipment for 3 hours per day in a workplace, propose alternative commuting methods and work patterns that improve the employee's environmental load score while keeping total working time unchanged.”
The server sends the constructed prompt sentence as textual data to the generative AI model. The server specifies model parameters, such as a model identifier, a maximum output length, and a randomness parameter, and receives a natural-language response from the generative AI model. The generative AI model internally comprises multiple layers of self-attention and feed-forward sub-layers, trained on sequences of tokens. In training, the model uses a loss function such as cross-entropy between predicted tokens and ground-truth tokens and updates its parameters via an optimization method such as stochastic gradient descent with adaptive learning rates. The model uses positional encodings to handle sequences and internal attention weights to capture relationships among features included in the prompt sentence. This architectural design allows the server to obtain coherent, context-aware proposals that relate numerical environmental indices to operative recommendations.
The server uses a candidate interpretation module to convert the natural-language proposal content into structured behavior plan candidates and equipment operation pattern candidates. The server applies rule-based text parsing and, in some embodiments, a secondary classification or extraction model to identify segments in the response that correspond to parameter changes, schedule changes, or operation mode changes. For each candidate, the server builds a structured object that includes fields such as target personnel or equipment identifiers, recommended parameter values (for example, reduced speed percentage, shifted operation time window), and qualitative descriptions. By structuring these candidates, the server enables deterministic verification and efficient storage in a “candidate_plans” data structure.
The server uses a candidate verification module to verify each candidate against operation constraint information. The server retrieves constraint records from storage, including permitted operating hours, maximum and minimum parameter values, safety margins, and equipment capability limitations. The server compares candidate parameter values against constraints, checks for conflicts such as overlapping operation windows or resource contention, and computes a feasibility flag. The server discards non-executable candidates and marks the remaining candidates as executable behavior plan candidates or executable equipment operation pattern candidates. In some embodiments, the server further sorts candidates by an estimated improvement score that the server computes by re-evaluating the environmental load index using hypothetical application of candidate parameters.
The server uses a presentation interface module to send executable candidates and associated indices to the terminal. The server packages the selected candidates, environmental load index values, performance values, and textual explanations derived from the generative AI model into response messages. The terminal receives the response messages and displays them on a display device. The terminal arranges information into views that show, for example, current environmental indices for personnel and equipment, historical graphs of performance values, and lists of candidate behavior plans and equipment operation patterns. The terminal highlights candidates expected to yield the largest reduction in environmental load index.
The user operates the terminal to review the displayed information. The user views charts, tables, and textual explanations on the display device and reads the rationale provided in natural language. The user assesses trade-offs between production requirements and environmental improvements and uses interactive controls, such as buttons or selection lists, to accept, modify, or reject individual candidates. The terminal captures these selection operations and sends corresponding messages back to the server, indicating the identifiers of accepted candidates or any user-specified parameter adjustments.
The server uses an update module to apply accepted candidates. The server updates behavior plan information in the “behavior_plans” table to reflect new commute modes, adjusted schedules, or altered task sequences. The server also updates operation conditions in equipment configuration records, such as target speeds, duty cycles, or operation time windows. In systems where equipment is connected to programmable control devices, the server propagates updated parameters to those devices via a control interface. In this way, the server indirectly modifies real equipment behavior, which results in concrete modifications in real-world power usage and motion patterns, rather than remaining at an abstract calculation level.
The server uses an incremental recomputation module to update environmental load indices and performance values after changes. Instead of recomputing all indices from scratch, the server identifies affected segments of behavior or equipment operation and recomputes indices for those segments only. The server loads updated records into in-memory data frames, recomputes feature vectors, and re-applies the scoring functions. The server then updates corresponding entries in “personnel_env_index,” “equipment_env_index,” and “performance_summary” tables. By restricting computations to changed segments, the server reduces processing time and resource usage and enables near real-time feedback to the terminal.
In one embodiment, the server uses a neural network-based scoring function as an alternative or in addition to rule-based functions. The server trains a feed-forward neural network with an input layer corresponding to features such as total energy, peak power, idle ratio, commute distance, and travel frequency; one or more hidden layers with nonlinear activation functions; and an output layer that provides a scalar environmental load index. During training, the server minimizes a loss function, for example, a mean-squared error between predicted indices and reference indices derived from domain expert evaluations, by updating connection weights using a gradient-descent-based algorithm. In this embodiment, the server stores trained weights in memory and performs inference repeatedly for new input feature vectors. This design allows the server to adapt the environmental load index calculation to complex relationships among features, improving the accuracy of the scoring compared to simple linear formulas.
In another embodiment, the server uses an internal generative model instead of, or in addition to, an external service. The server stores model parameters locally and executes inference on specialized hardware such as graphics processing units or tensor accelerators. The server maintains a local tokenization module for converting prompt sentences into token sequences, a multi-layer transformer network for processing tokens, and a detokenization module for converting predicted token sequences back into natural language. By executing inference locally, the server can reduce network latency and communication overhead, thereby improving response time and privacy control.
The server achieves technical improvements beyond mere automation of human tasks. By unifying behavior plan data and sensor data into a single feature space, the server avoids redundant data conversions and repeated full recomputations. The server's incremental recomputation module reduces computational complexity when only a subset of data changes, leading to faster updates and lower processor load. The server's candidate verification module systematically filters generative suggestions against hard constraints, which reduces the number of infeasible operations sent to equipment controllers and minimizes unnecessary communication with external systems. The server's structured prompt sentence construction ensures that the generative AI model processes compact, informative feature summaries instead of raw logs, which decreases token counts and improves inference speed and relevance.
The server also improves data management by storing preprocessed feature vectors and intermediate indices in a cache structure, which allows shared use across multiple computations of indices, performance values, and candidate evaluations. This caching reduces memory thrashing and disk I/O overhead, leading to measurable gains in throughput. Furthermore, the coordinated design of the feature extraction, environmental index computation, generative AI interaction, candidate verification, and incremental recomputation modules provides an integrated processing pipeline that reduces software complexity and improves maintainability.
In some embodiments, the server supports multiple variations. For example, the server may adopt different environmental index formulas for different types of equipment, such as stationary machines versus mobile robots, by changing feature weightings and thresholds. The server may also adapt prompt sentence templates depending on whether the target is personnel behavior or equipment operation. The server may incorporate additional constraint types, such as grid demand limits or temperature limits, in its candidate verification module. The terminal may be implemented as a handheld device, a wall-mounted panel in a factory, or a personal computer, and the user may be a line operator, a facility manager, or a sustainability officer.
Through these embodiments, the server, the terminal, and the user implement a system that not only computes environmental indices and presents them but also technically improves how a computing system manages heterogeneous time-series data, generates and filters generative AI-based recommendations, and updates control parameters for real equipment. The resulting architecture enhances processing efficiency, scalability, and reliability, and provides a concrete link between generative AI output, environmental scoring algorithms, and actual control or scheduling of equipment and personnel activities in the physical world.

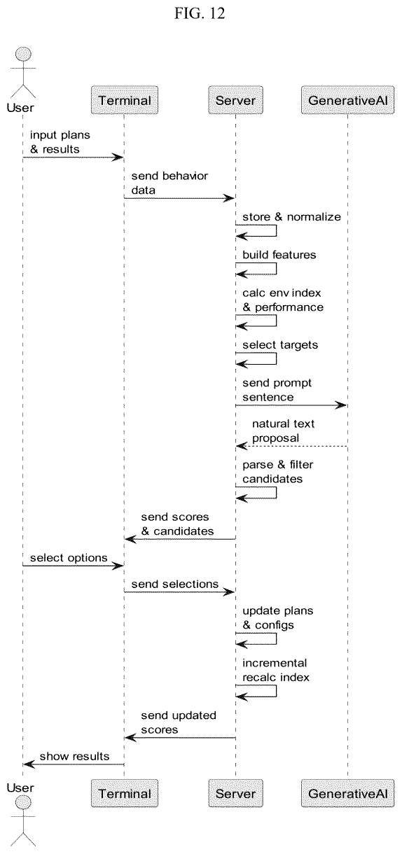

The following describes the processing flow using FIG. 12.

### Step 1:

Server receives raw behavior and equipment data.
Server accepts, as input, behavior plan information and behavior result information from the terminal, and operation state information and energy consumption information from sensors attached to equipment. Server parses incoming messages, validates required fields (personnel identifier, equipment identifier, timestamps, movement method, distance, energy value), and converts string-encoded values into internal numeric or categorical representations. Based on this input, server writes normalized records into persistent tables such as a behavior table and an equipment sensor table. The output of this step is a set of stored, schema-conforming records ready for further processing.

### Step 2:

Server constructs unified feature vectors. Server reads, as input, stored behavior records and equipment sensor records corresponding to a specified time window. Server performs data processing operations including unit conversion (for example, kilometers to meters, kWh to Wh), handling of missing values by interpolation or default values, and removal or capping of outliers using threshold rules. Server then encodes movement methods as categorical indices, computes derived quantities such as “energy per distance” and “idle energy ratio,” and packs these values into feature vectors for each personnel unit and each equipment unit. The output of this step is a collection of feature vectors stored in a feature cache or in-memory data structure.

### Step 3:

Server computes environmental load indices.
Server takes, as input, the feature vectors generated in Step 2. Server applies a scoring algorithm, for example multiplying each feature by a predetermined weight and summing the products, and optionally applying a nonlinear transformation such as a logistic function. Server may also use a trained neural network model to map the feature vector to a single scalar index. For each personnel unit and equipment unit, server calculates an environmental load index that numerically represents environmental impact. Server writes these indices to index tables. The output of this step is a set of environmental load index values associated with personnel identifiers, equipment identifiers, and time stamps.

### Step 4:

Server aggregates indices into performance values.
Server takes, as input, environmental load indices from Step 3 and time information for each index. Server groups indices by predetermined time units, such as days or months, and by unit type, such as personnel or equipment. Server performs aggregation operations, including summation, averaging, and calculation of variance for each group. Server generates performance values that summarize environmental performance over each time unit. Server stores these aggregated metrics in a performance summary table. The output of this step is a set of performance values linked to time intervals and evaluation units.

### Step 5:

Server selects targets requiring optimization.
Server reads, as input, the environmental load indices and performance values generated in Steps 3 and 4. Server compares each value against predefined thresholds or target ranges. Server identifies personnel units and equipment units with indices or performance values worse than a target level and selects them as optimization targets. Server may also compute rankings and identify the lowest-ranked segment. The output of this step is a list of target personnel and equipment identifiers with associated index values and performance values, stored as a target set.

### Step 6:

Server constructs structured prompt sentences for the generative AI model.
Server takes, as input, the target set from Step 5 together with relevant feature vectors, indices, performance values, and constraint information (allowed operation hours, parameter limits, safety margins). Server formats these data into human-readable text according to predefined templates. For example, server embeds numeric values and constraints into a prompt sentence such as: “The server has collected the following data for a robot: daily energy consumption: 50 kWh, movement distance: 2 km, operation time: 10 hours. Based on this data, calculate an environmental load score on a scale from 0 to 100, briefly explain the calculation logic, and propose at least three more energy-efficient operation patterns that keep the same production output.” Server also builds analogous prompt sentences for personnel behavior, such as: “Given that an employee commutes 20 km by car five days a week and uses high-energy equipment for 3 hours per day in a workplace, propose alternative commuting methods and work patterns that improve the employee's environmental load score while keeping total working time unchanged.” The output of this step is a set of complete prompt sentences ready for submission to the generative AI model.

### Step 7:

Server sends prompt sentences to the generative AI model and receives proposal content.
Server uses, as input, the prompt sentences created in Step 6 and configuration parameters such as model name, maximum output length, and randomness level. Server transmits each prompt sentence to a generative AI model endpoint via a network connection. The generative AI model processes the textual prompts using an internal neural network architecture and returns natural-language responses. Server receives these responses and parses them into textual blocks corresponding to explanations and recommendations. The output of this step is a set of natural-language proposal contents associated with the original prompt sentences.

### Step 8:

Server parses proposal content into structured candidates.
Server takes, as input, the natural-language proposal contents from Step 7. Server applies text parsing rules and, in some embodiments, a lightweight extraction model to identify parameter suggestions, schedule changes, or behavior modifications described in the proposals. Server converts these descriptions into structured candidate objects, each including a target identifier (personnel or equipment), proposed parameter values (for example, lowered speed, changed commute mode), and a qualitative description. Server stores these objects in a candidate data structure, such as a candidate table or in-memory list. The output of this step is a set of structured behavior plan candidates and equipment operation pattern candidates derived from the generative AI output.

### Step 9:

Server verifies candidates against constraint information and selects executable candidates.
Server reads, as input, the structured candidates from Step 8 and constraint information stored in constraint tables, including allowable operation times, parameter bounds, and safety rules. Server checks each candidate by comparing proposed values to constraints, verifying that no constraint is violated. Server marks candidates that satisfy all constraints as executable and discards or flags those that do not. Server may also simulate the effect of candidates by recomputing indices using hypothetical parameters to estimate improvement. The output of this step is a filtered set of executable behavior plan candidates and executable equipment operation pattern candidates, each annotated with an estimated improvement score.

### Step 10:

Server sends executable candidates and indices to the terminal.
Server uses, as input, the executable candidates from Step 9 and the associated environmental load indices and performance values for each target. Server assembles response messages that include, for each target, current indices, historical performance summaries, and one or more executable candidates with textual explanations and estimated improvement metrics. Server transmits these messages to the terminal via a communication interface. The output of this step is a delivered data set that the terminal can render for user interaction.

### Step 11:

Terminal presents indices and candidates to the user.
Terminal receives, as input, the data set from Step 10. Terminal parses the received information, constructs visual elements such as tables and charts for environmental load indices and performance values, and arranges lists of executable behavior plan candidates and equipment operation pattern candidates. Terminal displays current scores, trends, and candidate options on a display device. Terminal highlights key information such as low-scoring units and high-impact recommendations. The output of this step is a set of rendered user interface screens visible to the user.

### Step 12:

User reviews information and selects preferred candidates.
User views, as input, the indices, performance values, and candidate descriptions displayed by the terminal in Step 11. User evaluates the proposals in light of practical constraints and objectives and performs concrete UI actions, such as tapping an “accept” button for a candidate, modifying a recommended parameter value in an input field, or rejecting a candidate. User thereby generates selection operations corresponding to specific behavior plan candidates and equipment operation pattern candidates. The output of this step is a set of user selections and, optionally, user-adjusted parameter values captured by the terminal.

### Step 13:

Terminal sends user selections to the server.
Terminal takes, as input, the user's selection operations recorded in Step 12. Terminal encapsulates accepted and modified candidates in update messages, including identifiers of the selected candidates, any edited parameters, and user identifiers. Terminal sends these update messages to the server over a communication link. The output of this step is a stream of structured update requests arriving at the server.

### Step 14:

Server updates behavior plans and equipment operation conditions.
Server receives, as input, the update requests from Step 13. Server maps each request to corresponding records in the behavior plan table and equipment configuration table. Server applies updates by changing commute modes, adjusting schedules, or modifying equipment parameters such as speed, duty cycle, or operation windows. In configurations where equipment is connected to control devices, server translates updated conditions into control commands and sends them via a control interface to the relevant devices. Server records all changes in an audit log. The output of this step is an updated set of behavior plan records and equipment operation condition records, and, in some cases, adjusted control parameters applied to physical equipment.

### Step 15:

Server performs incremental recomputation of environmental indices and performance values.
Server uses, as input, the updated behavior plan information and equipment operation conditions from Step 14 together with existing feature vectors and indices. Server identifies which segments of data are affected by the changes and reloads only those segments from storage. Server recalculates feature vectors for the affected personnel and equipment, re-applies the environmental scoring algorithm, and updates environmental load indices and aggregated performance values for the relevant time intervals. By restricting computations to changed subsets, server reduces processing time compared to a full recomputation. The output of this step is a refreshed set of indices and performance values reflecting the newly applied behavior plans and operation patterns.

### Step 16:

Server and terminal provide updated feedback to the user.
Server takes, as input, the recalculated indices and performance values from Step 15. Server may optionally generate additional prompt sentences for further optimization if indices remain below a target. Server sends updated index and performance data to the terminal. Terminal receives the updated data, refreshes the user interface, and presents comparisons between previous and updated scores, such as percentage improvement or absolute reduction in environmental load indices. User then sees the direct effect of accepted candidates on environmental performance. The output of this step is an updated visual and textual feedback loop that supports ongoing refinement of behavior plans and equipment operation patterns.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented environmental support systems typically operate as static dashboards or rule-based advisors that calculate emissions or simple indicators and then display the values to a user. In such systems, a processor generally executes predetermined calculations on environmental data and outputs fixed recommendations or numerical scores. As a result, the role of the computing system is limited to a passive reporting tool, and the system does not actively adapt its guidance to user context, does not leverage generative models to produce tailored explanations, and does not optimize the interaction loop between environmental scoring, recommendation generation, and user motivation.

From the standpoint of computer technology, there are several technical issues. First, conventional systems do not integrate a structured scoring engine with a generative artificial intelligence model in a coordinated architecture. The processor typically calculates metrics such as emissions and energy usage, but there is no mechanism by which the processor automatically converts structured numerical results into prompt sentences that drive a generative model to produce context-aware guidance. This separation forces human operators or external applications to bridge between numeric computation and natural-language explanation, which leads to fragmented processing, redundant data handling, and increased latency.
Second, existing systems often treat individuals and groups in a uniform manner and do not provide a processing framework in which the processor calculates environmental burden scores at multiple aggregation levels (for example, per individual and per group), performs statistical aggregation over multiple time periods, and generates machine-consumable instructions for notification and gamification. Without such a framework, the system cannot systematically generate multi-period performance information or comparative information and cannot maintain a consistent, automated flow from score computation to motivational feedback. This results in inefficient computation pipelines, repeated queries, and ad hoc generation of user messages.
Third, when environmental burden scores are used for behavior change, conventional architectures typically require application developers to handcraft user messages, rankings, or rewards in application code. The processor executes fixed templates or hard-coded logic, so the system cannot flexibly adjust explanations or gamification elements in response to evolving data patterns or user behavior. Moreover, the absence of a standardized prompt-generation mechanism means that any integration with a generative AI model is manual, error-prone, and not optimized for performance or scalability.
Accordingly, there is a need for an improved computer-implemented system in which a processor not only computes environmental burden scores from behavior option data, but also automatically generates structured prompt sentences that encode these scores, time-series statistics, and comparative information, and provides these prompt sentences to a generative AI model. There is a further need for a processor that orchestrates the end-to-end flow: acquiring behavior information, computing multi-period scores at multiple aggregation levels, invoking a generative model in a controlled manner, and presenting optimized recommendations, explanations, and gamification elements to user terminals via communication interfaces. By improving how the processor coordinates numeric computation, prompt generation, and model interaction, the overall computer system can achieve more efficient processing, reduced developer burden, and more adaptive, high-quality guidance for users.

The specific processing by the specific processing unit 290 of the data processing device 12 in Example 2 is realized by the following means.

The present invention provides a server comprising a processor configured to acquire information on behavior options and calculate an environmental burden score for each behavior option based on a degree of impact on an environment, to compare the calculated environmental burden scores and select a behavior option having a higher environmental burden score, to generate text information including the selected behavior option and numerical information including the environmental burden score related to the selected behavior option, to provide a prompt sentence including the text information to a generative information processing model, to obtain, from the generative information processing model, explanation text or recommendation text for supporting an environmental burden reduction behavior of a user and present the explanation text or the recommendation text in association with the selected behavior option to a user terminal, to aggregate environmental burden scores over a plurality of periods by a statistical method and calculate performance information for each period, to calculate the environmental burden scores for each individual or for each group and provide a prompt sentence to the generative information processing model for instructing notification of the calculated environmental burden scores and the performance information for each period via a communication means, and to compare the environmental burden scores for each individual or for each group and provide a prompt sentence to the generative information processing model for instructing presentation of gamification elements including ranking information, achievement status information, or reward information. This enables an improved computer-implemented processing pipeline in which the processor tightly integrates structured environmental scoring, multi-period statistical aggregation, and automated prompt generation for a generative AI model, thereby reducing manual intervention, optimizing data flow between numeric computation and natural-language generation, and providing adaptive, high-quality recommendations and motivational feedback to user terminals in a scalable and technically efficient manner.

The term “behavior option” refers to an item of selectable conduct, operation, or activity that a user or group can choose to perform, including but not limited to a commuting method, work style, or resource usage pattern, which has a measurable impact on the environment.

The term “environmental burden score” refers to a numerical value computed by a processor that quantitatively represents a degree of environmental impact associated with a behavior option, where the value is derived from one or more environmental indicators such as emissions, energy consumption, or resource usage.
The term “degree of impact on an environment” refers to a magnitude or level of influence that a behavior option exerts on environmental factors, such as greenhouse gas emissions, energy use, or pollution, as represented by one or more measurable parameters used in score calculation.
The term “generative information processing model” refers to a machine-implemented model, such as a generative artificial intelligence model, configured to receive a prompt sentence as input and generate text information, including explanations or recommendations, as output based on learned patterns.
The term “prompt sentence” refers to a text string or structured textual input generated by the processor that encodes instructions, contextual data, or questions and is provided to a generative information processing model to cause the model to generate corresponding output text.
The term “explanation text” refers to text data generated by the generative information processing model or by the processor that describes reasons, background, or context for a particular behavior option or environmental burden score in human-readable language.
The term “recommendation text” refers to text data generated by the generative information processing model or by the processor that proposes one or more behavior options to a user, typically selecting options that are favorable according to environmental burden scores.
The term “user terminal” refers to an electronic device operated by a user, such as a computing device, communication device, or display device, configured to receive outputs from the server and present information such as explanation text or recommendation text.
The term “plurality of periods” refers to two or more discrete time intervals, such as days, weeks, or months, over which environmental burden scores are aggregated and performance information is calculated.
The term “statistical method” refers to a computational technique or algorithm, such as averaging, summation, variance calculation, or trend analysis, performed by the processor to aggregate and analyze environmental burden scores across the plurality of periods.
The term “performance information” refers to numerical or categorical data generated by the processor that summarizes environmental burden scores over the plurality of periods, including indicators such as total scores, average scores, or trends for individuals or groups.
The term “individual” refers to a single user, person, or user account for which an environmental burden score is calculated and tracked by the processor.
The term “group” refers to a collection of two or more individuals, entities, or organizational units, such as a department or team, for which aggregated environmental burden scores and performance information are calculated.
The term “communication means” refers to one or more hardware or software components, such as network interfaces, communication protocols, or messaging systems, used by the processor to transmit notifications or information to user terminals or external systems.
The term “notification” refers to a message transmitted via the communication means that informs an individual or group of environmental burden scores, performance information, or related updates.
The term “gamification element” refers to information or content, such as rankings, badges, or rewards, generated or presented by the processor to encourage user engagement or motivation by applying game-like mechanisms to environmental burden reduction behavior.
The term “ranking information” refers to data generated by the processor that orders individuals or groups according to environmental burden scores or performance information, such as from highest to lowest score.
The term “achievement status information” refers to data indicating whether individuals or groups have reached certain predefined goals, thresholds, or milestones related to environmental burden scores or performance information.
The term “reward information” refers to data specifying incentives, benefits, or acknowledgments, such as virtual badges, points, or tangible rewards, that are associated with achieving particular environmental performance levels.
The term “server” refers to a computing apparatus, including at least one processor and associated memory, configured to execute programs for acquiring behavior information, calculating environmental burden scores, interacting with a generative information processing model, and transmitting output to user terminals.
The term “processor” refers to one or more hardware processing units, such as central processing units or processing circuits, configured to execute instructions for acquiring data, computing scores, generating prompt sentences, controlling communication, and performing other operations described in the system.

In one embodiment, a server implements the claimed system as a network-connected computing apparatus that cooperates with one or more terminals operated by users. The server includes a processor, a memory, a storage device, and a network interface. The processor is, for example, a multi-core central processing unit conforming to a general-purpose instruction set architecture. The memory is, for example, a volatile memory device that stores executable instructions and runtime data structures. The storage device is, for example, a non-volatile storage device that stores environmental data, behavior option definitions, user and group identifiers, and historical performance information. The network interface is, for example, a wired or wireless communication interface capable of transmitting and receiving data packets via an internet protocol network.

The server executes system software such as an operating system and application software implementing the environmental burden scoring, prompt generation, and generative AI integration described herein. In one embodiment, the server executes an operating system that manages processes, memory, and network sockets. The application software is implemented as a web service using a web framework, such as a framework that provides an application programming interface for handling HTTP requests from terminals. The server accesses a relational database management system to store and retrieve structured records related to behavior options and environmental indicators.
The server stores environment-related data in tables that define a specific data structure. For example, the server stores behavior option records in a table that includes, for each option, a primary key, a category identifier, and one or more environmental parameters, such as carbon dioxide emission per unit action, energy consumption per unit action, distance, duration, and cost. The server stores user-related data in a table that includes, for each individual, a user identifier, group identifier, historical selections of behavior options, and historical environmental burden scores. The server stores group-related data in a table that includes, for each group, a group identifier, list of member user identifiers, and aggregated environmental burden scores.
The server calculates environmental burden scores using numerical processing libraries and data structures designed for efficient vectorized computation. The server loads a set of behavior option records from the database into a tabular in-memory structure, such as a two-dimensional array or a data frame, with each column storing a homogeneous data type (for example, 32-bit floating point values for emissions, energy, and distance). The server uses numerical procedures to normalize emissions, assign weights to different parameters, and derive a single environmental burden score for each behavior option. For example, the server maps raw emission values to a normalized scale by dividing each emission by a maximum emission value within the relevant option set, and the server applies an inverse transformation so that lower emissions yield higher scores. The server additionally combines other parameters, such as time and distance, via weighted linear or non-linear combinations, and stores the resulting scores in a dedicated score column of the data frame.
The server selects a recommended behavior option by performing comparison operations on the score column. The server uses a selection algorithm that scans the score column, performs a reduction operation (such as argmax) to identify the highest-scoring entry, and retrieves the associated behavior option key and environmental parameters. The server then constructs intermediate text data representing this selection, including plain-language labels for the behavior option, score values, emission values, and relevant contextual information such as user or group identifiers and time period.
The server generates a prompt sentence for a generative AI model by assembling a structured textual instruction that encodes both user context and computed environmental data. The server constructs the prompt sentence in a deterministic manner, using templates and insertion points for numeric values and option labels. For example, the server generates a prompt sentence such as:
“User prompt: ‘Please tell me the most environmentally friendly commuting option among train, bicycle, and car.’
Data: train: 500 g CO₂ per trip, bicycle: 0 g CO₂ per trip, car: 3000 g CO₂ per trip.
Task: As an environmental advisor, explain in simple English why bicycle is the best option and briefly compare it to the other options.”
In another example, the server generates a prompt sentence such as:
“Act as an environmental advisor and recommend the best commuting method with the lowest carbon footprint, given the options of bus, electric scooter, and private car. Use the following data: bus: 800 g CO₂ per trip, electric scooter: 50 g CO₂ per trip, private car: 2500 g CO₂ per trip.”
The server provides the generated prompt sentence to a generative AI model that is implemented as a neural network-based generative information processing model. In one embodiment, the generative AI model is a transformer-based language model having multiple self-attention layers, feedforward layers, and embedding layers. The model parameters include a token embedding matrix, multi-head attention weight matrices, and layer normalization parameters. The model is pre-trained on a large corpus of text and optionally fine-tuned on domain-specific environmental guidance data.
The server converts the prompt sentence into an internal token sequence by invoking a tokenizer component associated with the generative AI model. The tokenizer segments the prompt into subword tokens and maps each token to an integer index. The generative AI model then applies an autoregressive inference algorithm: the model processes the token sequence through multiple attention layers, applies learned weight matrices to compute attention scores and hidden state vectors, and generates a probability distribution over the next token at each step. The model selects tokens sequentially according to this distribution, using a decoding strategy such as greedy decoding or sampling with temperature adjustment, until an end-of-text token is produced or a maximum length is reached.
The server receives the generated token sequence and decodes it back into human-readable text, thereby obtaining explanation text or recommendation text. The server may perform post-processing on the generated text, such as removing extraneous whitespace, truncating text beyond a configured maximum, or filtering out inappropriate content according to predefined rules. The server then stores the explanation text in association with the selected behavior option, the user identifier, and the relevant time period.
The server aggregates environmental burden scores over a plurality of periods by using a statistical method. For each individual and group, the server maintains a time-series data structure that indexes scores by time interval. The server calculates, for each period, aggregated metrics such as total score, average score, maximum and minimum scores, and standard deviation. The server stores these metrics in a performance table and may also compute moving averages or trend indicators using rolling window operations. These statistical calculations are implemented in a vectorized manner over arrays or data frames to reduce computation time and memory overhead.
The server improves computer technology by implementing a unified data flow that reduces redundant computations and data transfer between modules. In particular, the server avoids re-tokenizing environmental data and user context at each step by caching intermediate representations of user profiles and by structuring prompt sentences in a machine-friendly template format. This design reduces the size of prompt sentences and shortens generative model input sequences, which in turn reduces inference time and memory usage within the generative AI model. By storing scores and statistics in columnar formats and using vectorized numerical operations, the server increases cache locality and computational throughput compared to naive row-by-row processing, thereby achieving faster score computation and lower energy consumption.
The server, rather than merely automating human judgment, performs a type of processing that is difficult for a human to execute manually at scale. The server ingests high-dimensional environmental data for many behavior options and many time periods, normalizes these data, and transforms them into optimized prompt sentences that encode numerical relationships and contextual constraints. The server applies algorithmic rules to select which data to include in the prompt sentence, in what order to present the data, and how to compress numeric information into concise textual form. For example, the server discards dominated options whose scores are substantially lower than the best option, and the server scales numeric values to human-comprehensible units before embedding them in the prompt, which reduces prompt length and improves clarity of the generative AI model's output.
The server controls the internal operation of the generative AI model by specifying decoding parameters such as maximum token length, sampling temperature, and top-k or top-p cutoffs. The server adjusts these parameters based on the category of behavior option or the sensitivity of the content. For example, the server uses a lower temperature and smaller top-k value for safety-critical or compliance-related prompts, which reduces variability in generated recommendations and increases determinism. By algorithmically adapting these parameters, the server improves the stability and reliability of the generative output compared with a naive implementation using fixed decoding settings.
The server leverages specific training and adaptation methods for the generative AI model. In one embodiment, the server stores a fine-tuning dataset consisting of pairs of input prompt sentences and preferred explanation or recommendation texts evaluated by domain experts. The server uses this dataset to further train the generative model via gradient-based optimization, minimizing a cross-entropy loss function between model-predicted token probabilities and reference token sequences. During fine-tuning, the server updates the model weights by computing gradients via backpropagation and applying an optimizer algorithm such as stochastic gradient descent with momentum or adaptive moment estimation. The server may apply data augmentation techniques, such as paraphrasing or reordering of non-critical parts of the prompt, to increase the diversity of training examples and improve the model's robustness.
The server implements a modular architecture in which an environmental scoring module, a statistics module, a prompt generation module, a generative model interface module, and a notification/gamification module communicate via defined data structures. Each module reads and writes structured objects, such as dictionaries or records containing fields for user identifier, group identifier, option list, scores, and textual content. This modular design allows the server to schedule module executions efficiently, cache intermediate results, and parallelize independent tasks. For example, the server executes score computation and statistics aggregation in parallel threads or processes, while the generative model inference runs on a separate accelerator device, such as a graphics processing unit, that is connected to the server via a high-speed bus. This concurrency and hardware utilization improve throughput and reduce latency from user request to terminal display.
The terminal operates as an input and output device that communicates with the server over a network. The terminal is, for example, a portable communication device or a stationary computing device that executes a client application. The terminal displays input fields that allow the user to provide text queries and select behavior option categories. The user enters a prompt sentence, such as:
“Please tell me the most environmentally friendly commuting option among train, bicycle, and car.”
The terminal transmits the prompt sentence and selection data to the server via a secure communication protocol. The server performs the processing described above, and the terminal receives a response that includes the selected behavior option, environmental burden scores, and explanation text. The terminal displays the information in a graphical user interface with visual indicators such as progress bars, color codes, or icons representing score levels. By using these graphics linked to server-computed scores, the terminal provides the user with a clear and immediate understanding of the environmental impact of each option. The user interacts with the system by refining queries and observing changes in the recommended behavior options and associated scores. For example, after receiving an initial recommendation, the user may input a new prompt sentence such as:
“Now consider that I sometimes carry heavy luggage. Please recommend the best option among train, bicycle, and car, and explain your reasoning.”
The terminal sends this new prompt to the server. The server adjusts the underlying scoring rules by incorporating additional constraints, such as feasibility under load, and recalculates environmental burden scores. The server then generates a new prompt sentence that summarizes both the numeric changes and the new constraints, and it obtains updated explanation text from the generative model. In this manner, the server dynamically adapts both numerical calculations and natural-language guidance, which enhances the system's responsiveness to user context.
The server also calculates environmental burden scores and performance information for multiple individuals and groups to support gamification elements. The server aggregates scores per user and per group over a plurality of periods and constructs ranking tables based on total or average scores. The server then generates prompt sentences that describe ranking results and achievements, such as:
“Generate a concise message summarizing that Group A has the highest environmental performance score this month, followed by Group B and Group C. Highlight that User X in Group A achieved the top individual score and describe one or two reasons based on commuting choices.”
The generative AI model returns gamified messages that the server delivers to terminals via notifications. These operations are not limited to business logic; they involve technical optimizations of ranking computation, storage layout of ranking tables to allow fast updates, and efficient construction of prompts that reuse cached score data, which together reduce server load and network traffic.
Alternative embodiments are possible within the scope of the claims. The server may use different scoring functions, such as non-linear functions emphasizing reductions beyond certain thresholds, or may include additional environmental factors such as water usage or particulate emissions. The server may implement the generative AI model on dedicated hardware accelerators, such as tensor processing units, for further reduction in inference time. The server may partition data across multiple database nodes and use distributed query execution to handle large volumes of behavior data. The terminal may be implemented as an in-vehicle device, an industrial control panel, or an appliance display, allowing recommendations to be tied directly to control of real-world equipment, such as setting operation modes of machinery or controlling charge schedules of electric vehicles, based on environmental burden scores and generated recommendations.
By configuring the server, terminal, and generative AI model in the foregoing manner, the system achieves technical effects such as improved processing speed for environmental scoring and statistics, reduced latency and communication overhead for generating and delivering personalized recommendations, enhanced accuracy and consistency in the transformation from numeric environmental data to natural-language guidance, and reduced memory and computation costs through structured data handling and optimized prompt construction. The system thereby constitutes an improvement in computer technology rather than a mere automation of human judgment.

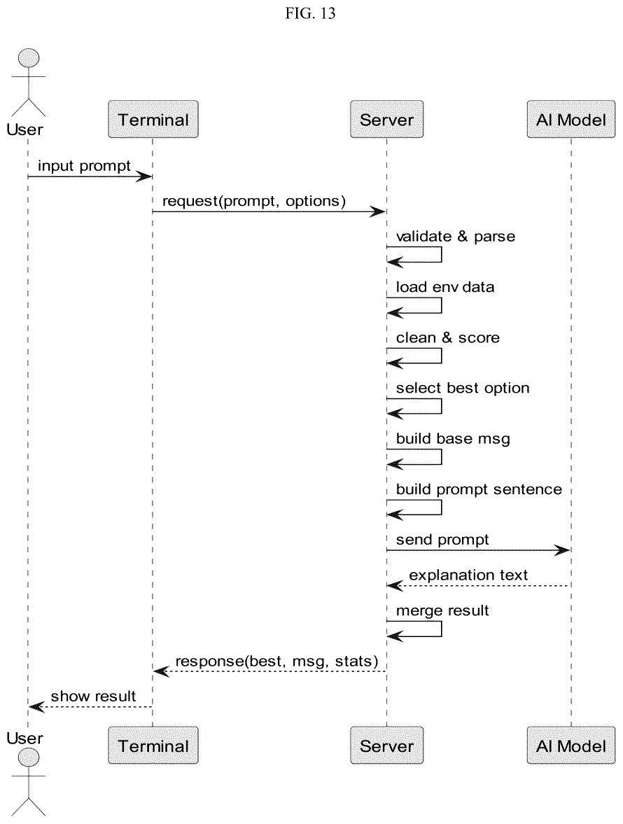

The following describes the processing flow using FIG. 13.

### Step 1:

The user operates the terminal to input an initial request.
The terminal displays an input field and receives a text string from the user as a natural-language request, such as a prompt sentence “Please tell me the most environmentally friendly commuting option among train, bicycle, and car.”
Input: user-entered text and any user-selected options displayed on the terminal.
The terminal packages this input as request data (including the prompt sentence and a list of candidate behavior options) and transmits the request data to the server over a network connection.
Output: a network request delivered to the server containing the user's prompt sentence and behavior option identifiers.

### Step 2:

The server receives the network request from the terminal and parses the content.
Input: request data including the user's prompt sentence and a list of behavior option identifiers.
The server validates the format, extracts the behavior option identifiers, and normalizes them into an internal representation, such as canonical option codes. The server discards invalid or duplicated identifiers and maps any aliases to standard labels.
Output: a cleaned list of behavior option codes and an associated user identifier and context derived from the request.

### Step 3:

The server retrieves behavior option records and environmental parameters from a storage system.
Input: the cleaned list of behavior option codes and user or group identifiers.
The server issues database queries to a relational database, requesting for each behavior option its stored environmental parameters, such as emission value, energy consumption, distance, and time. The server collects the resulting rows and loads them into an in-memory data structure, such as a table or data frame, with one row per behavior option and one column per environmental parameter.
Output: a structured table containing behavior option identifiers and associated environmental parameters for the requested set of options.

### Step 4:

The server preprocesses the environmental data and verifies data quality.
Input: the structured table containing raw environmental parameters for each behavior option.
The server inspects the table for missing values, inconsistent units, and out-of-range values. The server replaces missing values with estimated values based on default emission factors or historical averages, converts units (for example, kilograms to grams or hours to minutes) using arithmetic operations, and clips or flags extreme values according to configured thresholds. The server normalizes all environmental parameters into consistent numeric formats suitable for subsequent computation.
Output: a cleaned and normalized environmental data table in which each behavior option has complete and consistent parameter values.

### Step 5:

The server computes an environmental burden score for each behavior option.
Input: the cleaned and normalized environmental data table.
The server selects one or more environmental parameters, such as emission values, and transforms them into a dimensionless score using a scoring function. For example, the server calculates a normalized emission ratio for each option by dividing its emission by the maximum emission across all options, and then computes an inverted score so that lower emissions yield higher scores. The server optionally incorporates additional parameters such as distance or time using weighted combinations or non-linear functions, computing a final score value for each row and storing it in a score column of the table.
Output: an augmented environmental data table that includes, for each behavior option, a computed environmental burden score.

### Step 6:

The server selects an optimal behavior option based on the computed scores.
Input: the environmental data table including behavior option identifiers and environmental burden scores.
The server compares the score values across all rows using a selection algorithm, such as identifying the maximum value in the score column. The server resolves ties according to additional criteria, such as preferring lower time or distance when scores are equal. The server then extracts the row corresponding to the highest-ranked behavior option and stores its identifier, score, and key environmental parameters in an intermediate selection record.
Output: a selection record indicating the optimal behavior option and its associated numeric attributes.

### Step 7:

The server aggregates environmental burden scores for historical periods and for individuals or groups.
Input: the selection record, the user or group identifier, and historical score data stored in the database.
The server appends the newly computed score to a time-series record for the corresponding user or group, then retrieves all scores for a plurality of periods (such as days or months). The server applies statistical methods, such as summation, averaging, and variance calculation, over these scores to compute performance metrics per period and over all periods. The server updates and stores these metrics in dedicated performance tables linked to individual and group identifiers.
Output: updated performance information that includes period-based aggregated scores and summary statistics for the user and any associated group.

### Step 8:

The server constructs base recommendation and performance messages.
Input: the selection record, the environmental data table, and the updated performance information.
The server generates plain-language text that describes the selected behavior option, such as
“The most environmentally friendly commuting option among train, bicycle, and car is bicycle.” The server embeds numeric details, such as emission values and times, into the text using formatting rules. The server also generates a summary of performance information, such as “Your average environmental performance score this month increased compared to last month.” These base messages are stored as text strings and serve as deterministic outputs even without generative processing.
Output: base text messages summarizing the recommended behavior option and statistical performance.

### Step 9:

The server generates a prompt sentence for a generative AI model.
Input: the user's original request, the selection record, the environmental data table, and the base messages.
The server assembles a structured prompt sentence that combines the original user query, explicit numeric data for each behavior option, and an instruction describing the desired type of output. For example, the server constructs a prompt sentence such as:
“User prompt: ‘Please tell me the most environmentally friendly commuting option among train, bicycle, and car.’
Data: train: 500 g CO₂ per trip, bicycle: 0 g CO₂ per trip, car: 3000 g CO₂ per trip.
Task: As an environmental advisor, explain in simple English why bicycle is the best option and briefly compare it to the other options.”
The server arranges the text in a predefined template, inserting dynamic values into fixed segments to ensure consistency and compactness.
Output: a fully formed prompt sentence ready to be tokenized and supplied to the generative AI model.

### Step 10:

The server invokes the generative AI model and generates explanation or recommendation text.
Input: the prompt sentence produced by the server.
The server tokenizes the prompt sentence into subword units and encodes them as integer token IDs using a tokenizer component. The server then feeds the token sequence into a generative AI model, such as a transformer-based language model, that is stored in memory and executed on a processor or accelerator device. The generative AI model applies attention mechanisms and feedforward transformations to compute probability distributions over possible next tokens and produces an output token sequence according to configured decoding parameters, such as maximum length and sampling temperature. The server decodes the output tokens back into text, obtaining an explanation text or expanded recommendation text that reflects both the structured data and the user's request.
Output: generated explanation or recommendation text that elaborates on the selected behavior option and comparisons with other options. Step 11:
The server integrates generated text with base messages and gamification elements.
Input: the generated explanation text, the base recommendation and performance messages, and performance information including rankings and achievements.
The server merges the generated explanation text with deterministic messages, creating a composite response that includes the selected behavior option, key numeric values, personalized explanation, and any relevant gamification content such as rankings and achievements. The server formats this composite response into a structured response object, arranging sections for recommendation, explanation, and performance, and ensures that the content does not exceed configured length limits.
Output: a structured response object containing all text segments and associated numeric data to be sent to the terminal.

### Step 12:

The server transmits the structured response object to the terminal.
Input: the structured response object containing recommendation text, explanation text, and performance information.
The server serializes the response object into a network message and sends it over the network interface to the terminal using an appropriate communication protocol. The server may compress the data or remove redundant fields to reduce network load. The server records a log entry of the transaction, including timestamps, selected options, and latencies, for monitoring and optimization.
Output: a network response delivered to the terminal containing the complete recommendation and explanation payload.

### Step 13:

The terminal receives and displays the response to the user.
Input: the network response from the server containing text segments and numeric data. The terminal parses the received data, separates recommendation, explanation, and performance sections, and renders them in a graphical user interface. The terminal displays the recommended behavior option as a highlighted choice, shows explanation text in a readable paragraph, and visualizes performance metrics using graphical elements such as bars or charts. The user views the information, optionally scrolls through details, and may decide to adopt the recommended behavior option or issue a follow-up request.
Output: a visual presentation of the server-generated recommendation and explanation on the terminal's display, enabling further user interaction.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional environmental evaluation systems typically compute carbon-related scores or environmental indices by applying fixed formulas to activity logs, route data, or machine telemetry. These systems suffer from several technical limitations. First, the computation pipeline is rigid: environmental evaluation, route or behavior optimization, and user feedback are implemented as separate components that do not share a unified data model or adaptive parameters. As a result, recalculating scores or updating recommendations in response to new data (such as real-time traffic or sensor information) requires substantial recomputation and ad hoc integration logic, which increases processing latency and resource consumption on the computing platform.

Second, existing systems do not effectively incorporate user emotional state into the computational flow in a machine-usable way. Emotion recognition engines, where used, are typically bolted on at the presentation layer and do not influence the underlying scoring and optimization algorithms. This separation leads to redundant data processing, since emotional data must be reinterpreted at multiple layers, and prevents the processor from adjusting model parameters or evaluation weights at the time of score computation. Consequently, the system cannot optimize the trade-off between environmental impact and user experience within the core computation pipeline.
Third, generative models are often used merely to generate human-readable text, without being integrated into the numerical decision-making process. Conventional architectures treat generative models as post-processing tools that comment on already-decided scores and recommendations. This architecture forces the system processor to implement two separate reasoning paths: one for numerical optimization and one for explanation generation. Maintaining these separate paths increases complexity in data transformation, error handling, and consistency checking between numeric outputs and verbal explanations, and limits the ability to refine scores based on higher-level analysis performed by the generative model. Fourth, environmental scoring and behavior optimization are commonly implemented per transaction, without efficient support for time-series aggregation or adaptive model updates. Systems that attempt to compute monthly or periodic performance indices often rely on offline batch jobs that are loosely coupled to the real-time scoring engine. This disjoint processing leads to duplication of logic, inconsistent definitions of metrics, and delayed feedback, and makes it difficult to exploit temporal relationships between environmental scores, user emotional states, and behavior selections to improve future recommendations. Accordingly, there is a need for an improved computer-implemented system and processing method in which: (i) a processor maintains a unified, structured representation of behavior options, environmental indices, and emotional states; (ii) emotion data can directly and systematically modify scoring parameters within the core computation; (iii) a generative information processing model can be invoked with precise prompt sentences and structured data, not only to generate natural language, but also to verify or adjust composite evaluation values and to select optimal behavior options; and (iv) time-series environmental indices and emotional states can be aggregated and normalized in a consistent statistical framework, so that updated evaluation parameters and recommendations can be automatically fed back into subsequent computations. Such a system would improve the efficiency, adaptability, and technical performance of environmental evaluation and recommendation engines executing on general-purpose computing hardware.

The specific processing by the specific processing unit 290 of the data processing device 12 in Application Example 2 is realized by the following means.

The present invention provides a server comprising a processor configured to receive operation information and evaluate environmental impact to calculate an environmental evaluation index, acquire a user emotional state and weight or correct the environmental evaluation index in accordance with the emotional state, acquire route information and movement means information from an external information source regarding behavior options and calculate, for each behavior option, a composite evaluation value based on a plurality of evaluation elements including the environmental evaluation index, movement time, and cost, acquire emotion data from an emotion estimation mechanism that performs emotion estimation using a face image, a voice signal, or a text message as input and change calculation parameters of the composite evaluation value based on the emotion data, generate structured data including the behavior options, the environmental evaluation index, the composite evaluation value, and the emotional state and generate a prompt sentence that instructs a generative information processing model to analyze the structured data, to verify or adjust the composite evaluation value, to select an optimal behavior option, and to generate an explanatory sentence, provide the structured data and the prompt sentence to the generative information processing model, determine, based on output received from the generative information processing model, the optimal behavior option and a reason explanation thereof and output recommendation information to a display device or a control device, aggregate, by a statistical method, environmental evaluation indexes of a user or a machine collected over time, calculate a performance index for each unit period, correct the performance index based on a relationship between the performance index and the emotional state, generate notification data including a correction result, transmit the recommendation information and the notification data to a terminal device, receive a selection result or an actual behavior result from the terminal device, and use the selection result or the actual behavior result again as input data to update subsequent calculations of the environmental evaluation index and recommendations. This enables the computing platform to implement an integrated, adaptive scoring and recommendation pipeline in which emotional state influences numerical evaluation parameters in real time, in which a generative model participates directly in verification and adjustment of composite evaluation values through structured prompts, and in which time-series aggregation and feedback of performance indices reduce redundant computation and improve the technical efficiency, responsiveness, and consistency of environment-related decision support across users, devices, and time.

The term “operation information” refers to information representing activities of individuals, groups, devices, or systems, including at least one of schedule data, actual activity logs, transport modes, distances, energy consumption, cost, or other parameters used by the processor to evaluate environmental impact.

The term “environmental impact” refers to an effect of an activity, behavior option, or machine operation on a natural or built environment, including but not limited to greenhouse gas emissions, energy consumption, resource utilization, and pollution-related factors.
The term “environmental evaluation index” refers to a numerical or symbolic value calculated by the processor that quantitatively represents the environmental impact associated with a specific activity, behavior option, period, or entity.
The term “user emotional state” refers to a psychological or affective condition of a user at a given time, such as stress, joy, sadness, neutrality, or other emotional categories, which is obtained or inferred by the system.
The term “weight or correct” refers to modifying a value of the environmental evaluation index or of a composite evaluation value by applying a scaling factor, offset, normalization, or other numerical transformation according to predetermined rules or models.
The term “behavior option” refers to a selectable alternative for performing a task or achieving a goal, including, for example, different routes, transport modes, schedules, or operational settings that may be chosen by the user or the system.
The term “external information source” refers to any data-providing component outside the processor, including network-based services, databases, sensors, or application interfaces that supply route information, movement means information, traffic conditions, or other contextual data.
The term “route information” refers to data describing a path or sequence of locations between an origin and a destination, including at least one of coordinates, segments, distances, estimated travel times, and traffic conditions.
The term “movement means information” refers to data identifying one or more transport or movement modalities, such as pedestrian movement, powered vehicles, public transportation, or other conveyance categories, and characteristics thereof.
The term “composite evaluation value” refers to a value calculated by the processor for each behavior option that combines multiple evaluation elements, including at least the environmental evaluation index, movement time, and cost, according to a defined mathematical rule or model.
The term “evaluation element” refers to a measurable factor used to assess a behavior option or activity, such as environmental impact, time, cost, user comfort, safety, or other quantifiable attributes.
The term “emotion data” refers to machine-readable information representing a detected or inferred emotional state, including at least one of labels, confidence scores, intensity values, or temporal patterns output from an emotion estimation mechanism.
The term “emotion estimation mechanism” refers to a hardware and software combination configured to receive a face image, a voice signal, or a text message as input and to output emotion data indicating an estimated emotional state of a user.
The term “face image” refers to digital image data that includes at least a portion of a human face suitable for processing by the emotion estimation mechanism.
The term “voice signal” refers to audio data representing spoken utterances or other vocal expressions of a user used as input to an emotion estimation mechanism.
The term “text message” refers to character-based data representing natural-language content produced or received by a user and supplied to an emotion estimation mechanism for analysis.
The term “calculation parameters” refers to numeric coefficients, weights, thresholds, or other configuration values used by the processor when calculating the composite evaluation value or other indices.
The term “structured data” refers to data organized according to a predetermined schema or format, such as a table or hierarchical document, enabling a generative information processing model or the processor to access fields including behavior options, environmental evaluation indices, composite evaluation values, and emotional states.
The term “prompt sentence” refers to a machine-readable instruction sequence, expressed in natural language or in a mixed natural-language and formal syntax, that directs a generative information processing model to perform specific processing on provided data.
The term “generative information processing model” refers to a machine learning model configured to generate output data, including at least text or structured values, in response to input data and a prompt sentence, and capable of performing analysis, verification, adjustment, selection, or explanation of evaluation results.
The term “explanatory sentence” refers to natural-language output that explains, in human-readable form, at least one of a calculated composite evaluation value, a selected behavior option, or a change in evaluation due to emotion or other factors.
The term “recommendation information” refers to data output by the processor that specifies at least one selected behavior option and optionally includes associated scores, reasons, and instructions for presentation or control.
The term “display device” refers to any output apparatus configured to visually present information, including but not limited to a monitor, a mobile device screen, or an in-vehicle display.
The term “control device” refers to an apparatus, subsystem, or interface configured to receive commands or parameters from the processor and to influence the operation of a machine, vehicle, or other controlled entity in accordance with recommendation information.
The term “statistical method” refers to a procedure that uses statistical operations, such as aggregation, averaging, normalization, or distribution analysis, to process time-series or grouped environmental evaluation indices or related data.
The term “performance index” refers to a value derived from environmental evaluation indices over a unit period, representing performance of a user, a machine, or an organization with respect to environmental criteria.
The term “unit period” refers to a defined time span, such as a day, week, month, or other interval, over which environmental evaluation indices are aggregated to derive a performance index.
The term “notification data” refers to data generated for transmission to a terminal device that includes at least one of a performance index, a correction result based on emotional state, or explanatory content relating to such indices.
The term “terminal device” refers to any end-point computing apparatus used by a user to send input to and receive output from the server, including a personal computer, a portable terminal, a vehicle-mounted device, or other user interface device.
The term “selection result” refers to information indicating which behavior option or recommendation has been selected or accepted by a user on a terminal device.
The term “actual behavior result” refers to data representing an activity actually carried out by a user or a machine, which can be compared to or derived from a recommended behavior option.
The term “electronic communication means” refers to any hardware and protocol combination that enables digital data transfer between the processor and external devices, including wired and wireless communication systems.
The term “individual-unit information” refers to operation information associated with a single person or entity, enabling calculation of environmental evaluation indices or performance indices on an individual basis.
The term “organization-unit information” refers to operation information associated with a group of individuals or components, such as a department or division, enabling calculation of environmental evaluation indices or performance indices on an organizational basis.
The term “motivation information” refers to information generated to encourage users to improve their environmental evaluation indices or performance indices, including comparative, ranking, or reward-related content.
The term “reward element” refers to a component of motivation information that represents incentives, such as points, levels, or benefits, provided based on environmental performance.
The term “badge element” refers to a symbolic token or marker within motivation information that visually or logically represents an achievement, level, or status of a user.
The term “ranking element” refers to information indicating an order or position of a user or group relative to others based on environmental evaluation indices or performance indices.
The term “department basis” refers to a grouping level in which evaluation or comparison is performed between organizational subdivisions, such as teams or departments, rather than solely between individual users.
The term “visualize and present” refers to processing and outputting data in a graphical or otherwise perceptible form, such as via charts, lists, icons, or textual descriptions, to make the data understandable to a user.

In one embodiment, a server, a terminal, and a user cooperate to implement the claimed system. The server is realized as one or more physical computing devices, for example a rack-mounted computer or a virtual machine in a data center, including at least one central processing unit (CPU), a main memory, non-volatile storage, and a network interface. The server executes an operating system and multiple software modules implemented, for example, in a high-level programming language such as Python or in a combination of languages. The server further executes middleware such as a web framework (for example, a generic application framework), a database management system (for example, a relational database server), and a machine learning runtime (for example, a numerical computation library and a deep learning library).

The terminal is realized as a user-operated computing apparatus, such as a personal computer, a portable terminal, or a vehicle-mounted device including a display, user input hardware (for example, a touch panel, a keyboard, or hardware buttons), a camera, a microphone, local storage, and a communication module. The terminal executes a client-side application, for example a web browser rendering a web application or a native mobile application, and communicates with the server via a communication network using a secure communication protocol.
The user operates the terminal to provide operation information, to observe recommendation information output by the server, and to select or reject proposed behavior options. The user may be an individual, a member of an organization, or an operator responsible for machines or vehicles.
In one concrete configuration, the server implements a data acquisition module, an environmental evaluation module, an emotion integration module, a generative model interface module, a time-series aggregation module, and an output control module. The server further maintains a database schema including at least: a behavior_option table, an environmental_index table, an emotion_state table, a performance_index table, a user table, and an organization table. Each table stores data in structured form: for example, the behavior_option table stores fields such as option_id, user_id, timestamp, route_id, transport_mode, estimated_distance, estimated_time, estimated_cost, and references to environmental and emotional data.
The server uses a numerical computation library and a structured data library (for example, a table-processing library) to process these tables as in-memory data structures, such as data frames. The server represents each behavior option as a row with typed columns for evaluation elements, including at least an environmental evaluation index, a movement time, a cost, and optionally safety, comfort, or other attributes. The server represents the environmental evaluation index as a numeric value, for example a floating point value, derived from raw environmental impact data such as energy consumption or greenhouse gas emission estimates.
The server calculates environmental impact using explicit formulae that combine base emission factors (for example, emission per unit distance or per unit energy) with measured or estimated quantities such as distance and energy consumption. The server obtains emission factors from a configuration table or from external information sources such as generic environmental databases. The server applies deterministic mathematical operations, including multiplication, addition, normalization, and scaling, using vectorized operations provided by the numerical computation library. By storing emission factors and intermediate results in data frames, the server avoids repeated parsing and enables efficient batch computation over many behavior options.
The terminal captures user emotional state by using its camera and microphone to record face images and voice signals under user consent. The terminal executes a local emotion estimation mechanism that includes a face detection module based on a convolutional neural network, a feature extraction backbone (for example, a deep residual network), and a classification head mapping feature vectors to discrete emotional categories such as stress, joy, neutrality, and sadness. The terminal may alternatively send raw or preprocessed multimedia data to a separate emotion estimation device, which returns emotion labels and confidence scores. The terminal transmits these emotion data to the server together with identifiers linking them to specific behavior options or sessions.
In one implementation, the emotion estimation mechanism uses a neural network trained on labeled image and audio datasets. The neural network architecture includes multiple convolutional layers, non-linear activation functions, pooling layers, and fully connected layers, with parameters (weights and biases) optimized using a gradient-based learning algorithm such as stochastic gradient descent with momentum or an adaptive optimization method. The training is performed by minimizing a loss function such as cross-entropy between predicted emotion probabilities and ground-truth labels. Data augmentation techniques, including random cropping, horizontal flipping, and intensity scaling, may be applied to improve generalization. The server stores the resulting model parameters and may update them periodically via re-training when new labeled emotion data become available. The server associates emotion data with behavior options and environmental evaluation indices by joining records based on user identifiers and timestamps. The server stores emotion labels and confidence scores in the emotion_state table. The emotion integration module of the server then applies explicit adjustment rules to the environmental evaluation index and composite evaluation values. For example, the server multiplies the environmental evaluation index by a factor less than one when the user is in a highly stressed state and a factor greater than one when the user is in a relaxed state, or shifts the weight assigned to movement time versus environmental impact in the composite evaluation calculation. These adjustment rules are implemented as parameterized functions, not simply as display-level filters, and are applied before final recommendation selection.
The server computes the composite evaluation value for each behavior option by combining evaluation elements using a mathematically defined aggregation function. In one embodiment, the server normalizes each evaluation element across all candidate options by computing minimum and maximum values and applying min-max scaling. The server then forms a weighted sum of normalized values, for example:
composite_value=w_env*normalized_environmental_index+w_time*normalized_time+w_cost*normalized_cost,
where w_env, w_time, and w_cost are weights that may themselves be functions of the current emotional state and other context. The server may further introduce non-linear transformations, such as piecewise-linear penalty functions for exceeding thresholds in time or cost, to reflect practical constraints. These operations are performed with vectorized array functions, which reduces processing time and improves numerical stability compared with naive per-option loops.
The server uses a generative AI model implemented as a generative information processing model. In one embodiment, the generative model is a transformer-based neural network with multiple self-attention layers, feed-forward layers, and positional encodings, trained on large-scale text and structured data to follow natural-language instructions (prompt sentences) and to output structured and unstructured responses. The generative model is executed by a separate computation service reachable via an application programming interface. The server does not treat the generative model as a black box that only produces free-form text; instead, the server constructs structured prompts that include explicit instructions together with machine-readable behavior option data.
The server converts its internal data frames into a serialized representation that encodes, for each option, keys and values for route characteristics, environmental indices, composite evaluation values, and emotion states. The server then generates a prompt sentence that instructs the generative model to perform specific operations, for example: verify whether the composite evaluation values correctly reflect a stated prioritization rule, adjust the ranking if necessary, select one or more optimal behavior options, and generate concise explanations suitable for the user. One example of such a prompt sentence is:
“The system has computed several candidate routes and driving modes, with their environmental scores, travel times, and costs, and the user is currently stressed. Please review these options, confirm or adjust their composite scores according to a stronger weight on shorter travel time but still penalizing high environmental impact, select the best option, and explain the reason to the user in no more than five sentences.”
The server sends both the prompt sentence and the structured data to the generative model service and receives a response that may contain a revised order of options, adjusted scores, and explanation text. The server parses the response according to an expected format, for example a tagged or delimited representation, and updates its internal composite evaluation values where the generative model has provided consistent adjustments. By delegating certain ranking and trade-off refinements to the generative model, while the server maintains control over base computations and schema, the system reduces the complexity of hard-coded rule sets and can adapt more flexibly to multi-objective preferences. This interaction improves technical performance by reducing the amount of server-side code changes required to adjust decision logic, while still keeping the core numerical pipeline explicit and auditable.

The server operates a time-series aggregation module that periodically reads environmental evaluation indices and emotion states from the database and computes performance indices per unit period, such as per day or per month, for each user and for each machine or organization unit. The server uses statistical methods, such as aggregation, averaging, and normalization, performed on data frames via vectorized operations. The server then optionally applies correction factors derived from relationships between emotional states and environmental performance; for example, the server may analyze distributions of emotion labels over time and adjust performance indices to account for persistent adverse emotional conditions. This integrated statistical pipeline allows both real-time recommendations and periodic summaries to share the same definitions of indices and adjustment rules, reducing inconsistency and avoiding duplicated computation paths. In one embodiment, the server further integrates with machines or vehicles to achieve tangible control effects. For instance, the server can provide recommendation information not only to a display device but also to a vehicle control device. The server transmits a selected route and driving mode as control parameters to the terminal in a vehicle, which in turn forwards these parameters to an on-board controller via a vehicle communication bus. The on-board controller uses these parameters to adjust speed limits, acceleration profiles, or energy management strategies. Because the recommended behavior options are derived from a composite of environmental indices, real-time sensor data, and emotion-inclusive weighting, the vehicle operates in a manner that reduces energy consumption while maintaining user comfort. The use of integrated data structures and pre-computed composite values enables the vehicle to receive concise control directives, thereby reducing communication load and enabling faster reaction compared with sending raw environmental and emotion data and requiring full recomputation onboard.

The system yields technical improvements over conventional architectures in several ways. First, by representing behavior options, environmental indices, and emotional states as unified structured data, the server can perform batch processing and vectorized operations, which reduce computational overhead and improve processing speed. Second, by adjusting scoring parameters at the numerical level based on emotion data, rather than applying post-hoc visual filters, the system reduces redundant conversions and re-evaluations, thus improving computational efficiency and reducing error. Third, by using prompt sentences that explicitly instruct the generative model to verify and refine composite evaluation values, the system leverages the generative model to perform higher-level consistency checks and trade-off reasoning that would otherwise require complex handcrafted rules, thereby simplifying server logic without sacrificing precision. Fourth, by coupling time-series aggregation with emotion-aware corrections and feeding resulting performance indices back into future computations, the system steadily improves personalization and reduces variance in recommendations, which can be measured as a technical improvement in prediction error for environmental impact and user satisfaction.
In contrast to simple automation of human tasks, the system implements non-conventional computer-internal procedures. For example, when computing composite evaluation values, the server does not follow human-intuitive sequential selection but instead applies multi-dimensional normalization over large batches of options and integrates emotion-derived parameters into the weight vectors at computation time. The generative model is not merely asked to imitate a human advisor; it is constrained to operate on structured data, to output adjusted scores, and to follow a specified schema, which allows the server to enforce consistency checks and to revert to baseline values when the output violates defined mathematical constraints. Such interaction patterns are specific to machine execution and yield reproducible numerical behaviors unachievable by ad hoc human judgment alone. The server may implement alternative embodiments to suit different environments. In another embodiment, the emotion estimation mechanism resides entirely on the server, which receives raw multimedia data from the terminal. The server then performs inference using a deep neural network deployed on specialized hardware, such as a graphic processing apparatus. In a further embodiment, the generative model is trained or fine-tuned by the server operator using domain-specific datasets of behavior options, environmental profiles, and emotional patterns. The training uses a loss function that combines cross-entropy for text tokens and a regression loss for numeric scores, enabling the generative model to learn both verbal explanation and numeric adjustment behaviors concurrently. The server may also store multiple parameter sets for weighting evaluation elements and select an appropriate set depending on user type, machine type, or external conditions.
The terminal may present recommendation information not only as text and static graphics but also as dynamic visualizations and control widgets. For example, in a vehicle-mounted terminal, the terminal displays the selected route on a map, overlays environmental score indicators along the path, and provides interactive controls for the user to request alternative trade-offs, such as prioritizing lowest environmental impact or shortest time. When the user changes preferences, the terminal sends updated preference parameters to the server, which recalculates composite values using the same data structures and algorithms, and may issue a new prompt sentence to the generative model. This tight loop between terminal input, server-side vectorized recomputation, and generative-model-assisted ranking demonstrates that the system is designed as a technical control and optimization platform rather than a static reporting tool.
In another embodiment, the server applies the same framework to industrial machines. The server receives machine telemetry, such as energy usage and throughput, from sensors via an industrial communication protocol. The server computes environmental evaluation indices at a machine level, integrates operator emotional data where available, and sends control suggestions or alert thresholds to a supervisory control system. By aggregating machine performance over time and correcting for human factors, the server allows the supervisory system to schedule maintenance or adjust operating parameters more efficiently, which can be quantified as reduction in peak energy usage and improved production stability. The described embodiments can be modified in various ways without departing from the scope of the claims. The server may use different data structures (for example, columnar in-memory formats) or different neural network architectures (for example, recurrent networks or graph neural networks) to implement emotion estimation or generative modeling. The terminal may be a wearable device that continuously monitors emotion and passes it to the server opportunistically. The generative model interface may support multiple languages via language tags in the prompt sentences. In each case, the core technical arrangement remains: a processor uses structured representations of behavior options, environmental evaluation indices, and emotional states; modifies scoring parameters based on emotion at computation time; coordinates with a generative AI model via explicit prompt sentences and structured data; and integrates time-series aggregation and feedback to improve the technical performance of environmental decision support and, where applicable, control of physical equipment.

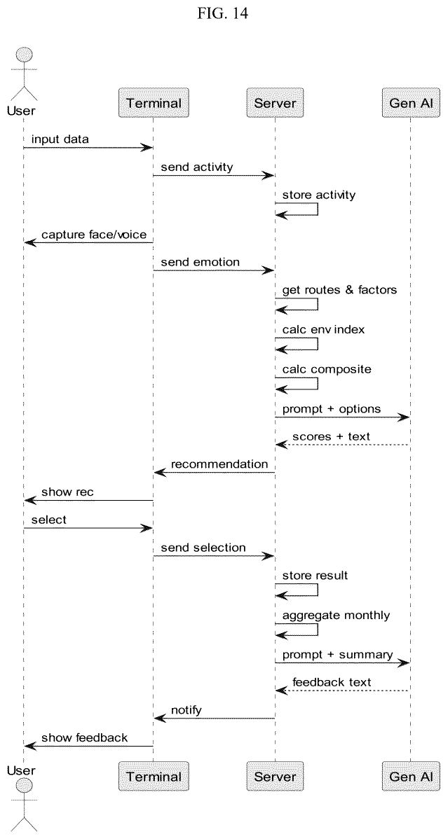

The following describes the processing flow using FIG. 14.

### Step 1:

The user operates the terminal to input operation information and preferences.
The user enters, as input, data such as planned activities, actual travel records, origin and destination locations, preferred transport modes, time constraints, and optional comments describing mood or constraints.
The terminal validates the input format (for example, checks that locations are valid and times are chronological) and packages the data into a structured message including user identifiers and timestamps.
The terminal outputs a request containing the structured operation information and sends it to the server via a secure communication protocol.

### Step 2:

The server receives and stores the operation information.
The server takes, as input, the structured message from the terminal, parses the payload, and extracts fields such as user ID, activity type, start time, end time, origin, destination, and preliminary scores if present.
The server performs data processing by mapping the extracted fields into rows of database tables and by normalizing data types (for example, converting date strings to internal time formats).
The server outputs stored records in a persistent storage system, updating tables such as a behavior_option table and a user_activity_log table.

### Step 3:

The server enriches the behavior options with contextual route and movement information.

The server takes, as input, the stored behavior_option records containing origin, destination, and intended movement modes.

The server performs data processing by calling external information sources, such as generic mapping or traffic services, to obtain route candidates, distances, estimated travel times, and possible transport means. The server converts the returned JSON to in-memory tabular data structures and associates each candidate route with the corresponding behavior option.
The server outputs an enriched behavior_option dataset that includes route identifiers, distances, travel times, congestion indicators, and available movement means for each option.

### Step 4:

The server calculates a base environmental evaluation index for each behavior option.
The server takes, as input, the enriched behavior_option dataset and emission factor data from a configuration table or external source, where emission factors define environmental impact per unit distance or per unit energy for each movement type.
The server performs data computation by joining or merging the behavior options with corresponding emission factors and by multiplying distances or energy amounts by these factors to yield estimated emissions or energy usage. The server applies further normalization, such as converting raw emissions into a standardized environmental evaluation index scale.
The server outputs a dataset in which each behavior option includes a base environmental evaluation index representing its relative environmental impact.

### Step 5:

The terminal acquires and transmits emotion data to the server.
The terminal takes, as input, sensor data including face images captured by a camera, voice signals captured by a microphone, and text messages typed by the user.
The terminal performs data processing by invoking a local or remote emotion estimation mechanism: the terminal preprocesses images and audio, feeds them into a trained neural network or emotion classifier, and receives emotion labels and confidence scores (for example, stressed with 0.8 confidence).
The terminal outputs a compact emotion data record containing user ID, timestamp, emotion label, and confidence, and transmits this record to the server.

### Step 6:

The server integrates emotion data with behavior options and environmental indices.
The server takes, as input, emotion data records received from the terminal and existing behavior_option records with environmental evaluation indices.
The server performs data processing by aligning emotion records to behavior options using user identifiers and time windows; the server may, for example, assign the most recent emotion state prior to a decision to all candidate behavior options at that decision time. The server stores the matched emotion states in an emotion_state table and links them via foreign keys to behavior options.
The server outputs an augmented dataset where each behavior option is associated with both a base environmental evaluation index and a current user emotional state.

### Step 7:

The server computes composite evaluation values for the behavior options.
The server takes, as input, the augmented dataset containing environmental indices, time estimates, costs, and associated emotion states.
The server performs data computation by first normalizing each numerical evaluation element across the set of options (for example, using min-max scaling or z-score normalization). The server then applies a defined aggregation function, such as a weighted sum, to combine normalized environmental impact, travel time, and cost. The server adjusts the aggregation weights or penalty functions in accordance with the emotion state (for example, increasing the weight of time when the user is stressed).
The server outputs, for each behavior option, a composite evaluation value that quantitatively expresses the overall desirability of the option under the current environmental and emotional conditions.

### Step 8:

The server prepares structured data and a prompt sentence for a generative AI model.

The server takes, as input, the set of behavior options with their environmental indices, composite evaluation values, emotion states, and relevant context (such as user preferences and constraints).

The server performs data processing by converting this set into a structured representation, such as a sequence of labeled records describing each option and its scores. The server then constructs a prompt sentence in natural language that instructs the generative AI model to analyze this structured data, verify or adjust composite scores, choose the best option, and generate a human-readable explanation. An example prompt sentence is: “The system has computed several candidate routes and driving modes with environmental scores, times, and costs, and the user is currently stressed. Please review these options, confirm or adjust the composite scores emphasizing shorter time but still penalizing high environmental impact, select the best option, and explain your reasoning in no more than five sentences.”
The server outputs the prepared structured data and the prompt sentence as input for a generative AI model interface.

### Step 9:

The server interacts with the generative AI model and receives refined results.
The server takes, as input, the structured data and the prompt sentence prepared in Step 8. The server performs data communication by sending these inputs to a generative AI model service through an application programming interface. The generative AI model processes the prompt and structured data to produce an output that includes, for example, reordered behavior options, possibly adjusted composite values, and an explanatory text. The server then parses this output according to expected markers, extracting the refined ranking, any score modifications, and explanation sentences.
The server outputs an updated option list with final composite evaluation values and associated explanation text that reflects the generative AI model's analysis.

### Step 10:

The server selects the optimal behavior option and generates recommendation information.
The server takes, as input, the updated option list and associated explanation text obtained after generative AI processing.
The server performs data processing by selecting the option with the highest final composite evaluation value or by applying a selection rule that may also consider thresholds or constraints (for example, maximum acceptable travel time). The server then assembles recommendation information containing the selected option identifier, route instructions or control parameters, environmental and other scores, and the explanation text.

The server outputs recommendation information ready for transmission to a display device or, when applicable, to a control device for equipment such as a vehicle or a machine.

### Step 11:

The server transmits recommendation information and receives user decisions.
The server takes, as input, the recommendation information generated in Step 10.
The server performs data communication by sending this information to the terminal over the network. The server may format the data as a structured message containing all fields necessary for visualization and, where applicable, for control parameter configuration. The terminal receives and decodes this message, then presents route maps, scores, and explanations on a display. The user observes the recommendation and may accept, modify, or reject it via the terminal interface.
The terminal outputs the user's selection result, such as acceptance of the recommended option or selection of an alternative, and sends this result back to the server.

### Step 12:

The server records the selection result and actual behavior result for feedback.
The server takes, as input, the selection result from the terminal and, when available, actual execution data collected from sensors or logs (for example, the route actually driven, the energy consumed, or the time taken).
The server performs data processing by writing the selection result and actual behavior result into dedicated tables, allowing comparison between recommended and realized behavior. The server may compute deviations in environmental impact or time, and store such deviations as additional evaluation metrics.
The server outputs updated historical records that will serve as training or calibration data in future evaluations and may be used to refine parameter settings and decision rules.

### Step 13:

The server aggregates environmental evaluation indices over time to compute performance indices.
The server takes, as input, historical environmental evaluation indices, selection results, and emotion states stored in the database.
The server performs statistical processing by grouping records according to user, organization unit, machine, and unit period (for example, month), and by computing aggregated measures such as total environmental index, average composite value, variance, and counts of high-impact events. The server can also compute correlations between emotion states and environmental performance. Based on these computations, the server derives performance indices per unit period and may apply corrections to reflect emotional conditions.
The server outputs performance_index records indicating periodic environmental performance and associated emotional adjustments for each relevant entity.

### Step 14:

The server generates notification data and personalized feedback using a generative AI model.
The server takes, as input, the performance_index records and historical activity breakdowns for each user or organization unit.
The server performs data processing by forming a concise summary of key metrics and trends for each entity and by constructing a prompt sentence that instructs the generative AI model to create personalized feedback. An example prompt sentence is: “Given this user's monthly environmental scores and activity breakdown, write a short message that praises improvements, identifies the top two sources of environmental burden, and proposes three practical changes for next month. Limit the message to about 200 words.” The server sends this summary and prompt to the generative AI model and receives back a tailored text message.
The server outputs notification data that include performance indices and the generated feedback message, ready for transmission to the terminal via an electronic communication channel.

### Step 15:

The terminal presents notification data and the user reviews and reacts. The terminal takes, as input, the notification data containing performance indices and feedback messages from the server.
The terminal performs data processing by formatting the performance metrics into charts or tables and by rendering the generated text in a readable layout on the display. The user reads the performance summary and feedback, and may adjust future behavior preferences or schedules accordingly using the same terminal interface.
The terminal outputs any updated preferences or new operation information entered by the user, which the terminal then sends to the server, thereby closing the loop and providing continuous input for improved environmental evaluation and recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

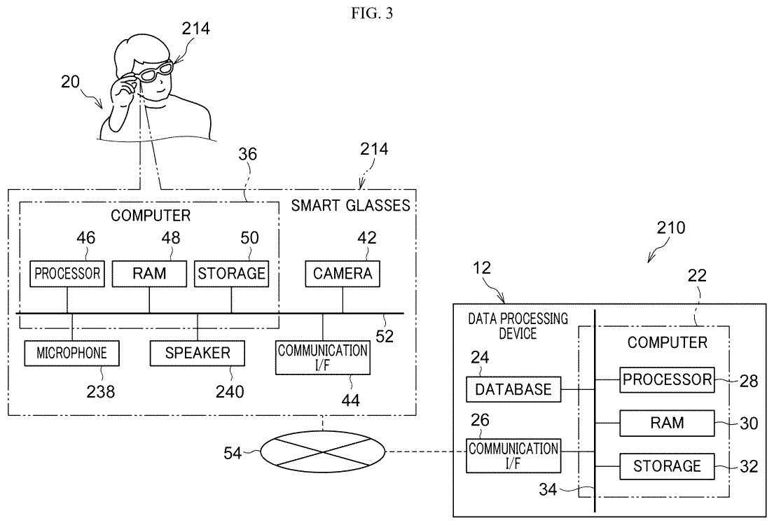

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

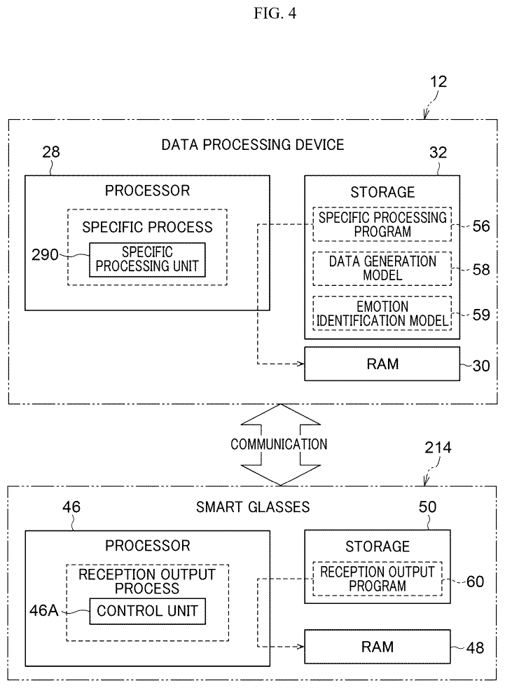

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

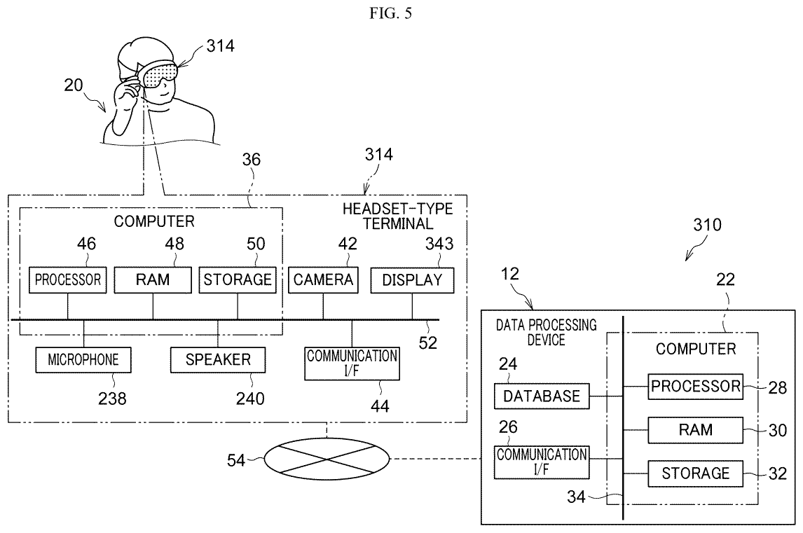

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

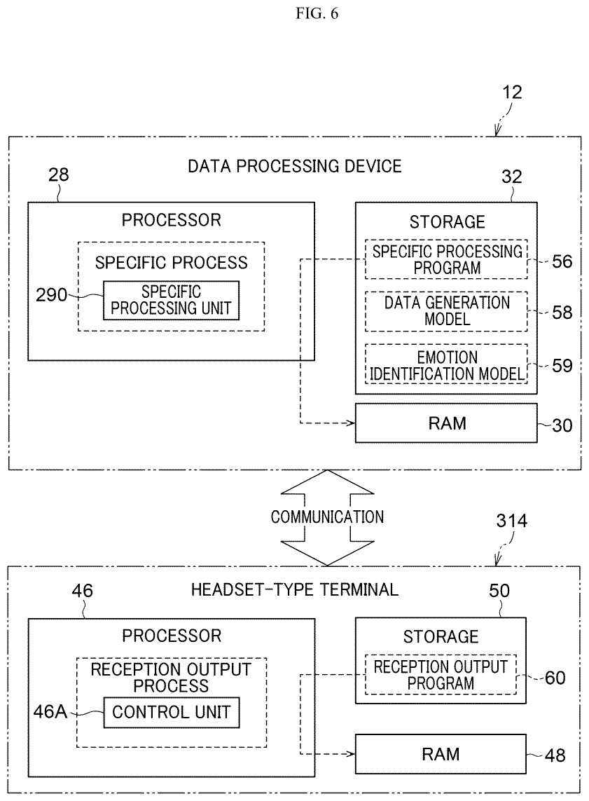

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

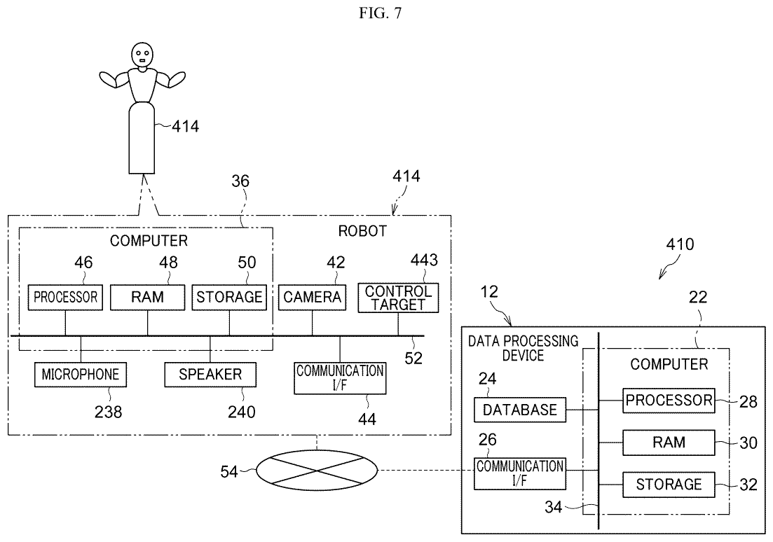

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

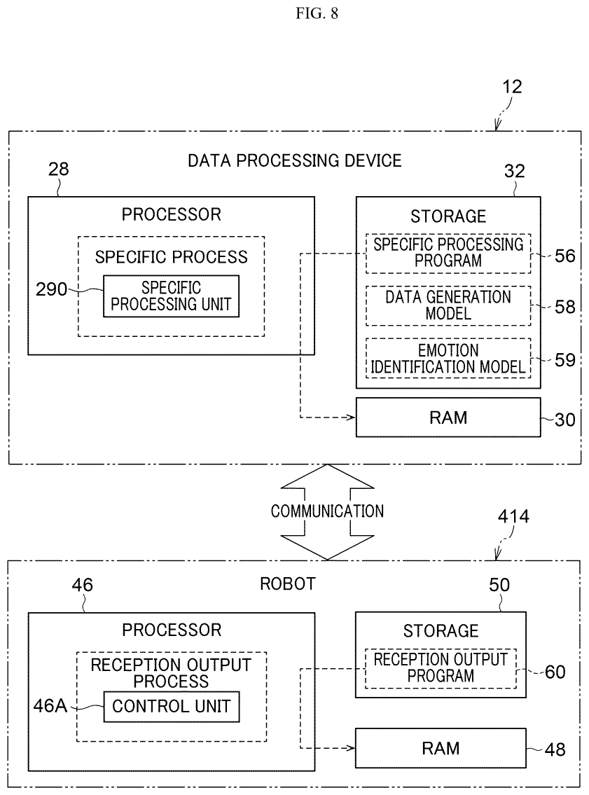

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

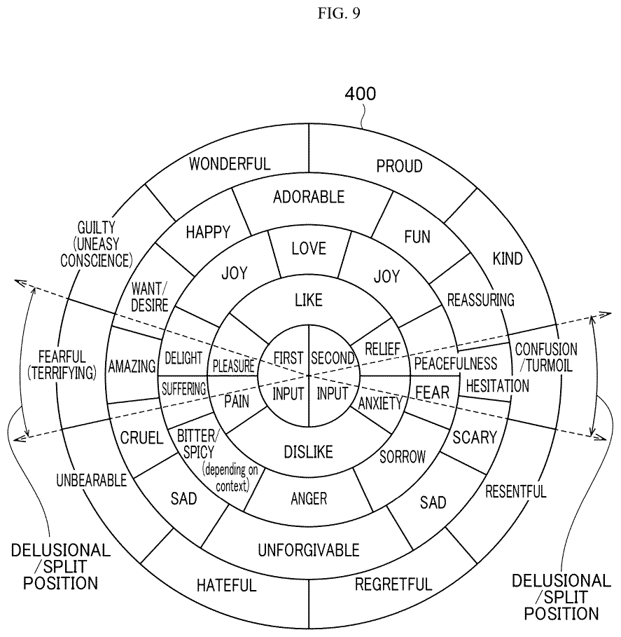

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

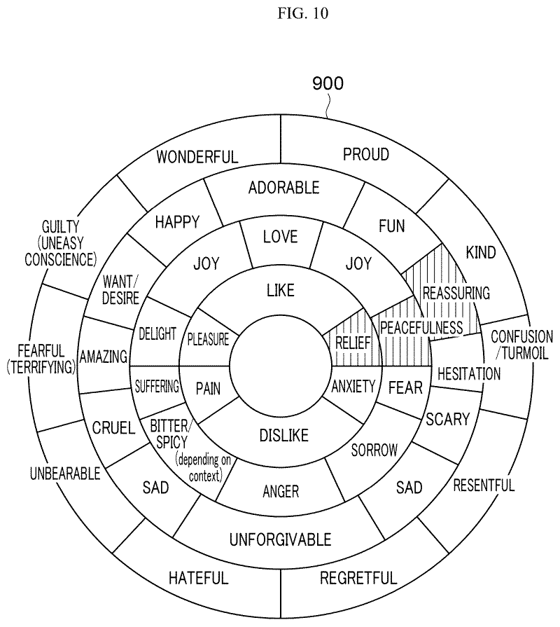

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to receive activity information including schedule information and performance information for personnel, the activity information including at least transport mode information, travel distance information, and energy consumption information, as input data from a terminal device,
acquire, from a storage device, greenhouse gas emission factor information corresponding to the transport mode information and electric power emission factor information, and calculate an environmental load index by performing arithmetic processing between the travel distance information and the greenhouse gas emission factor information and between the energy consumption information and the electric power emission factor information,
apply predetermined scaling processing or normalization processing to the environmental load index to calculate a carbon-neutral score, and aggregate the carbon-neutral score in a time series to generate evaluation information,
acquire an emotional state of a user, generate a prompt sentence including at least the emotional state and the carbon-neutral score as input information, the prompt sentence specifying a presentation method or an adjustment method of the carbon-neutral score, and provide the prompt sentence to a generative AI model,
identify, on the basis of the environmental load index and the carbon-neutral score, at least one schedule pattern that reduces environmental load, generate a prompt sentence including content for recommending the schedule pattern as a schedule with a high score, and provide the prompt sentence to the generative AI model,
aggregate, for each predetermined aggregation period, the environmental load index and the carbon-neutral score by a statistical method on the basis of the schedule information and the performance information to calculate performance information for each individual unit and each organizational unit, and
generate output data for a display device including the carbon-neutral score and the performance information, and transmit the output data to the terminal device so that the carbon-neutral score and the performance information are visually displayed.

### Supplementary 2

The system according to supplementary 1,
wherein the processor is configured to
generate the performance information for each individual unit and each organizational unit, generate a prompt sentence specifying notification content and notification timing of the performance information, provide the prompt sentence to the generative AI model, and cause an information delivery device to distribute the performance information by electronic communication on the basis of a response from the generative AI model.

### Supplementary 3

The system according to supplementary 1,
wherein the processor is configured to
generate, on the basis of the carbon-neutral score and the performance information, a prompt sentence for designing gamification elements including at least one of a comparison index, a ranking index, and an incentive index for each individual unit and each group unit, provide the prompt sentence to the generative AI model, and present the gamification elements on the basis of a response from the generative AI model to motivate acquisition of a higher carbon-neutral score.

### Application Example 1

### Supplementary 1

A system comprising a processor,
wherein the processor is configured to
acquire behavior plan information and behavior result information related to personnel, and quantify an environmental load index based on movement method information and energy consumption information included in the behavior plan information and the behavior result information,
collect operation state information of equipment and energy consumption information obtained from a detection device connected to the equipment in a time-series manner, and calculate the environmental load index for each item of the equipment,
aggregate the environmental load index of the personnel and the environmental load index of the equipment, and calculate performance values for predetermined time units by using a statistical method,
generate a prompt sentence for causing a generative information processing model to generate candidates of behavior plans and equipment operation patterns having higher scores that contribute to reduction of the environmental load based on the environmental load index and the performance values, and provide the prompt sentence to the generative information processing model,
obtain proposal content expressed in natural language from the generative information processing model, verify the proposal content based on the environmental load index and operation constraint information of the equipment, and select executable behavior plan candidates and executable equipment operation pattern candidates,
output the selected behavior plan candidates and equipment operation pattern candidates to a display device, and present the selected behavior plan candidates and equipment operation pattern candidates as options expected to improve the environmental load index to a user, and acquire a selection operation of at least one of the presented behavior plan candidates and the presented equipment operation pattern candidates from the user, update the behavior plan information and operation conditions of the equipment based on the selection operation, and recalculate the environmental load index by using the updated behavior plan information and updated operation state information.

### Supplementary 2

The system according to supplementary 1,
wherein the processor is configured to
generate the environmental load index for each personnel unit and for each organizational unit, and provide a prompt sentence to the generative information processing model for causing notification of the environmental load index and the performance values via an external communication means.

### Supplementary 3

The system according to supplementary 1,
wherein the processor is configured to
provide a prompt sentence to the generative information processing model for generating presentation content to add gamified elements including ranking information, achievement information, and reward information based on the environmental load index and the
performance values for each personnel unit and for each organizational unit, and present the gamified elements to the user via the display device.

### Example 2

### Supplementary 1

A system comprising a processor,
wherein the processor is configured to
acquire information on behavior options and calculate an environmental burden score for each behavior option based on a degree of impact on an environment,
compare the calculated environmental burden scores and select a behavior option having a higher environmental burden score,
generate text information including the selected behavior option and numerical information including the environmental burden score related to the selected behavior option, and provide a prompt sentence including the text information to a generative information processing model,
obtain, from the generative information processing model, an explanation text or a recommendation text for supporting an environmental burden reduction behavior of a user, and present the explanation text or the recommendation text in association with the selected behavior option to a user terminal, and
aggregate environmental burden scores over a plurality of periods by a statistical method and calculate performance information for each period.

### Supplementary 2

The system according to supplementary 1,
wherein the processor is configured to
calculate the environmental burden scores for each individual or for each group, and provide a prompt sentence to the generative information processing model for instructing notification of the calculated environmental burden scores and the performance information for each period via a communication means.

### Supplementary 3

The system according to supplementary 1,
wherein the processor is configured to
compare the environmental burden scores for each individual or for each group, and provide a prompt sentence to the generative information processing model for instructing presentation of gamification elements including ranking information, achievement status information, or reward information.

### Application Example 2

### Supplementary 1

A system comprising a processor,
wherein the processor is configured to
receive operation information and evaluate environmental impact to calculate an environmental evaluation index, and
acquire a user emotional state and weight or correct the environmental evaluation index in accordance with the emotional state, and
acquire route information and movement means information from an external information source regarding behavior options, and calculate, for each behavior option, a composite evaluation value based on a plurality of evaluation elements including the environmental evaluation index, movement time, and cost, and
acquire emotion data from an emotion estimation mechanism that performs emotion estimation using a face image, a voice signal, or a text message as input, and change calculation parameters of the composite evaluation value based on the emotion data, and generate structured data including the behavior options, the environmental evaluation index, the composite evaluation value, and the emotional state, and generate a prompt sentence that instructs a generative AI model to analyze the structured data, to verify or adjust the composite evaluation value, to select an optimal behavior option, and to generate an explanatory sentence, and provide the structured data and the prompt sentence to the generative AI model, and
determine, based on output received from the generative AI model, the optimal behavior option and a reason explanation thereof, and output recommendation information to a display device or a control device, and
aggregate, by a statistical method, environmental evaluation indexes of a user or a machine collected over time, calculate a performance index for each unit period, correct the performance index based on a relationship between the performance index and the emotional state, and generate notification data including a correction result, and
transmit the recommendation information and the notification data to a terminal device, receive a selection result or an actual behavior result from the terminal device, and use the selection result or the actual behavior result again as input data to update subsequent calculations of the environmental evaluation index and recommendations.

### Supplementary 2

The system according to supplementary 1,
wherein the processor is configured to
include individual-unit information and organization-unit information as the operation information, generate the environmental evaluation index and the performance index on an individual basis and on an organization basis, and provide to the generative AI model a prompt sentence that instructs distribution, via an electronic communication means, of the environmental evaluation index or the performance index for the individual unit and the organization unit.

### Supplementary 3

The system according to supplementary 1,
wherein the processor is configured to
provide to the generative AI model a prompt sentence that instructs generation of motivation information including information for mutually comparing and ranking the environmental evaluation index or the performance index on an individual basis and on a department basis, and including at least one of a reward element, a badge element, and a ranking element, and visualize and present the motivation information to promote acquisition of a high score by a user.

What is claimed is:

1. A system comprising:
circuitry configured to:
receive, via a communication interface coupled to a packet-switched network, structured activity information comprising transport mode information, travel distance information, and energy consumption information from a terminal device;
acquire emission factor data from a storage device corresponding to the transport mode information, and calculate an environmental load index by combining the travel distance information with the emission factor data and the energy consumption information with electric power emission factor data;
apply normalization processing to the environmental load index to compute a performance score, and aggregate the performance score as time-series data to generate evaluation information for each aggregation period and for each individual unit and each organizational unit;
acquire an emotional state of a user, and generate structured prompt sentences for input to a generative neural network model, the prompt sentences comprising at least the performance score, the evaluation information, and the emotional state, the prompt sentences specifying at least one of a presentation method, an adjustment method, a notification content, a notification timing, or a gamification element related to the performance score;
receive, from the generative neural network model in response to the prompt sentences, responses comprising recommended activity patterns that reduce the environmental load index, notification configurations, and gamification configurations; and
generate output data comprising the performance score, the evaluation information, and user interface control information reflecting the responses, and transmit the output data to the terminal device via the communication interface.

2. The system according to claim 1, wherein the circuitry is configured to receive the structured activity information comprising schedule information and performance information for personnel from the terminal device, and to derive the transport mode information, the travel distance information, and the energy consumption information from the schedule information and the performance information.

3. The system according to claim 2, wherein the circuitry is configured to acquire greenhouse gas emission factor data corresponding to the transport mode information and electric power emission factor data from the storage device, and to calculate the environmental load index by computing a product of the travel distance information and the greenhouse gas emission factor data and a product of the energy consumption information and the electric power emission factor data, and summing the products.

4. The system according to claim 3, wherein the structured activity information comprises schedule information and performance information relating to work-related travel and energy usage activities of personnel, and the emission factor data represents a greenhouse gas emission rate per unit of transport distance for a plurality of transport mode types.

5. The system according to claim 4, wherein the circuitry is configured to aggregate the performance score by computing at least a sum, an average, or a variance of the performance score across a plurality of individual units and a plurality of organizational units within a predetermined aggregation period.

6. The system according to claim 1, wherein the circuitry is configured to acquire the emotional state by applying an emotion identification model to input data received from the terminal device comprising at least one of text data, voice data, or behavioral pattern data, and to classify the emotional state into an emotional category.

7. The system according to claim 6, wherein the circuitry is configured to generate the structured prompt sentences by encoding at least the performance score, the evaluation information, and the classified emotional category as structured text segments with associated field labels, and to concatenate the structured text segments into a single input sequence for the generative neural network model.

8. The system according to claim 7, wherein the circuitry is configured to specify, within the prompt sentences, at least one of a tone adjustment instruction based on the classified emotional category, a presentation format instruction based on whether the performance score satisfies a threshold, or a comparison instruction based on the evaluation information for individual units and organizational units.

9. The system according to claim 1, wherein the circuitry is configured to parse the responses from the generative neural network model to extract the recommended activity patterns as structured data comprising at least an activity type and an estimated environmental load reduction for each recommended activity pattern.

10. The system according to claim 9, wherein the circuitry is configured to generate user interface control information comprising a ranked list of the recommended activity patterns ordered by estimated environmental load reduction, and to transmit the ranked list to the terminal device for display as selectable activity recommendations.

11. The system according to claim 1, wherein the circuitry is configured to generate notification configurations from the responses of the generative neural network model specifying at least a notification timing and a notification content, and to transmit notifications to the terminal device via the communication interface according to the notification configurations.

12. The system according to claim 11, wherein the circuitry is configured to generate gamification configurations from the responses of the generative neural network model specifying at least a scoring rule, a ranking display format, and a badge assignment condition, and to incorporate the gamification configurations into the user interface control information to cause the terminal device to display individual and organizational performance scores as comparative rankings.

13. The system according to claim 1, wherein the circuitry is configured to calculate a monthly aggregate performance value by applying a statistical computation comprising at least one of a sum, a mean, or a weighted average to performance score values accumulated over a calendar month, and to generate time-series evaluation information for each individual unit and each organizational unit based on the monthly aggregate performance value.

14. The system according to claim 13, wherein the circuitry is configured to detect a trend in the time-series evaluation information by applying a regression analysis or a moving average computation, and to incorporate the detected trend as an additional input to the prompt sentences to instruct the generative neural network model to adjust the recommended activity patterns based on the trend.

15. The system according to claim 1, wherein the circuitry is configured to generate a prompt sentence for input to the generative neural network model specifying a comparison instruction that causes the generative neural network model to compare performance scores among individual units and organizational units, and to generate a notification comprising a comparison result for transmission to the terminal device.

16. The system according to claim 1, wherein the circuitry is configured to store the performance score, the evaluation information, and the responses in the storage device as historical performance data, and to retrieve the historical performance data to incorporate into subsequent prompt sentences as context information for the generative neural network model.

17. The system according to claim 16, wherein the circuitry is configured to detect an improvement or a decline in the performance score relative to the historical performance data, and to adjust at least one of a notification content or a gamification element in the prompt sentences based on the detected change to motivate the user toward activity patterns associated with reduced environmental load index values.

18. A system comprising:
circuitry configured to:
receive, via a communication interface coupled to a packet-switched network, structured activity information comprising transport mode information, travel distance information, and energy consumption information from a terminal device;
acquire greenhouse gas emission factor data and electric power emission factor data from a storage device, compute an environmental load index by multiplying the travel distance information by the greenhouse gas emission factor data and the energy consumption information by the electric power emission factor data and summing the products, and apply normalization processing to compute a performance score;
aggregate the performance score as time-series data for each aggregation period and for each individual unit and each organizational unit to generate evaluation information;
acquire an emotional state of a user by applying an emotion identification model to input data from the terminal device, and generate structured prompt sentences encoding the performance score, the evaluation information, and the emotional state with instruction prefixes specifying at least a presentation method, a notification content, and a gamification element;
receive, from a transformer-based generative neural network model in response to the prompt sentences, responses comprising recommended activity patterns, notification configurations, and gamification configurations; and
generate output data comprising the performance score, the evaluation information, and user interface control information reflecting the responses, and transmit the output data to the terminal device via the communication interface.

19. The system according to claim 18, wherein the circuitry is configured to parse the recommended activity patterns from the responses as structured data comprising an activity type and an estimated environmental load reduction, generate a ranked list ordered by estimated environmental load reduction, and transmit the ranked list to the terminal device for display as selectable recommendations with associated impact indicators.

20. A method comprising:
receiving, via a communication interface coupled to a packet-switched network, structured activity information comprising transport mode information, travel distance information, and energy consumption information from a terminal device;
acquiring emission factor data from a storage device corresponding to the transport mode information, and calculating an environmental load index by combining the travel distance information with the emission factor data and the energy consumption information with electric power emission factor data;
applying normalization processing to the environmental load index to compute a performance score, and aggregating the performance score as time-series data to generate evaluation information for each aggregation period and for each individual unit and each organizational unit;
acquiring an emotional state of a user, and generating structured prompt sentences for input to a generative neural network model, the prompt sentences comprising at least the performance score, the evaluation information, and the emotional state, the prompt sentences specifying at least one of a presentation method, an adjustment method, a notification content, a notification timing, or a gamification element related to the performance score;
receiving, from the generative neural network model in response to the prompt sentences, responses comprising recommended activity patterns that reduce the environmental load index, notification configurations, and gamification configurations; and
generating output data comprising the performance score, the evaluation information, and user interface control information reflecting the responses, and transmitting the output data to the terminal device via the communication interface.
